(19) United States
(12) Patent Application Publication
(10) Pub. No.: US 2026/0184992 A1
(43) Pub. Date: Jul. 2, 2026

(54) RELEASE AGENT AND CORROSION INHIBITOR FORMULATION AND METHOD OF USE

(71) Applicant: POLYMER SOLUTIONS GROUP, Cleveland, OH (US)

(72) Inventors: Gary M. FREEMAN, Macon, GA (US); Malcolm D. FERNANDO, Bonaire, GA (US); Cody J. Wykle, Perry, GA (US)

(73) Assignee: POLYMER SOLUTIONS GROUP, Cleveland, OH (US)

(21) Appl. No.: 19/004,831

(22) Filed: Dec. 30, 2024

(51) Int. Cl. C09K 15/18

(52) U.S. Cl. CPC C09K 15/18

(57) ABSTRACT

A waterborne external release agent for producing ligno-cellulose composites such as oriented strand board (OSB), particle board (PB) and medium density fiberboard (MDF), which employ isocyanate-based adhesives such as pMDI is provided. The release agent as a formulation includes effective amounts of at least one tertiary ethoxylated fatty amine, effective amounts at least one of an acidic alkyl phosphate ester and an acidic phosphate ester ethoxylate, or combinations thereof, with the balance water. The formulation can also include a defoamer and a nonionic surfactant. The formulation can be applied to mats and/or metal platens when making the ligno-cellulosic composites, wherein the effective amounts of the at least one tertiary ethoxylated fatty amine and the at least one of an acidic alkyl phosphate ester and an acidic phosphate ester ethoxylate, or combinations thereof provide improved release properties, corrosion inhibition for metal surfaces, and minimum film build up when making ligno-cellulosic composites.

### FIELD OF THE INVENTION

The present invention relates to a release agent and corrosion inhibitor formulation intended for use in making engineered wood composite products. The formulation, as a waterborne formulation, includes a combination of at least one tertiary ethoxylated fatty amine and at least one of an acidic alkyl phosphate ester and/or an acidic phosphate ester ethoxylate, or a combination thereof. The combination of the two active ingredients in the right proportions synergistically results in improved release properties, corrosion inhibition, and anti-masking properties when the formulation is used in the method of making the engineered wood composite products.

### BACKGROUND ART

The use of release agents and/or corrosion inhibitors of various types in preparing textiles and molded articles from lignocellulosic materials is well known. The following is a discussion of prior art related to the use of phosphate esters and/or organic amines as part of release agents and/or corrosion inhibitors for use in ligno-cellulose applications.

U.S. Pat. No. 8,551,238 of Massidda and Short discloses an anti-corrosive package which can be added to release agents that are used in preparing textiles and molded articles from ligno-cellulosic materials, concrete or polyurethane foam. The disclosed anti-corrosive package comprises at least one oxygen scavenger that binds dissolved oxygen within an aqueous carrier and at least one film forming corrosion inhibitor. The oxygen scavenger that is employed can be diethylhydroxylamine, a sulfite, an alkyl or aryl hydrazine, a tannin, a carbohydrazide or a mixture thereof. Diethylhydroxylamine is preferred and it functions as both an oxygen scavenger that binds dissolved oxygen and as a metal passivator whereby the diethylhydroxylamine is used in an amount of 10-20 wt. %, based on the total weight of the anti-corrosive package. The preferred film forming corrosion inhibitor is dimethylamide which is used in an amount of 8-20 wt. %, based on the total weight of the anti-corrosive package. The above combination of anti-corrosive additives can then be mixed with a release agent formulation intended for providing release properties of lignocellulosic materials from metal pressing surfaces at dosage levels from 0.1 to 1.0 mg of solids/cm² of surface area whereby the release agent formulation comprises an alkali metal salt of a tall oil fatty acid plus an additional wax or oil. This art does not teach the use of ethoxylated fatty amines in combination with phosphate esters to yield a non-corrosive, non-masking external release agent for producing lignocellulose materials.

US Patent Publication No. 20230174703 of Xu, et. al. discloses a binder composition for lignocellulose composites comprising: (a) a polyfunctional isocyanate or an isocyanate prepolymer, (b) a tackifier, and (c) a phosphate ester based internal release agent whereby the isocyanate prepolymer is obtained by reacting a polyfunctional isocyanate with a polyfunctional polyol. The tackifier is a vinyl acetate homopolymer or copolymer having a Mw of about 10,000 to 2,000,000 and the phosphate ester is an ethoxylated phosphate ester or a mixture of an alkyl phosphate ester and an ethoxylated phosphate ester. It was disclosed that adding a phosphate ester into the binder composition helped to improve mold releasing capability by functioning as an internal release agent.

U.S. Pat. No. 4,257,995 of Mclaughlin, et. al. discloses the preparation of a particle board using a polyisocyanate-phosphorous compound that yields improved release properties from the face of the platen pressing surface used in their formation. This is accomplished by incorporating minor amounts of a mixture of certain acidic mono-aliphatic and di-aliphatic phosphate esters or the corresponding pyrophosphates, into the polyisocyanate to be used as the binder for the composite. The polyisocyanates and the acidic phosphate esters and or the pyrophosphates, are then applied to the wood particles separately, or after pre-blending one with the other whereby the phosphate additives serve as an internal release. In some instances, the acidic phosphate esters can react with the isocyanate functional group to produce carbamoyl phosphates. All the aforementioned phosphates can also be utilized as the ammonium, alkali metal, alkaline earth metal and amine salts thereof through their neutralization with the associated base (e.g., ammonium hydroxide, alkali or alkaline earth metal hydroxide, organic amine, etc.).

U.S. Pat. No. 4,376,089 of Bogner, et. al. discloses a binder system for particle board which incorporates an internal release agent and comprises a mixture of polyisocyanate resin, furfural and a phosphate ester. In this particle board making process, the phosphate ester is placed into solution with the furfural and subsequently blended with the polyisocyanate. Increased stability of the binder system is observed as well as providing for increased mold releasing capabilities.

U.S. Pat. No. 5,744,079 of Kimura, et. al. discloses a process for producing a compression molded article of a ligno-cellulose type material by employing a binder composition that contains a combination of the following components: (A) an organic polyisocyanate, (B) an aqueous emulsion of a wax having a melting point ranging from 50° C. to 160° C., (C) an organic phosphate ester derivative and optionally (D) water. The wax emulsion and the organic phosphate ester both serve as internal release agents in this application. In particular, the organic phosphate ester is a mono-ester and/or di-ester of phosphoric acid derived from aliphatic alcohols having 12 to 20 carbon atoms and the alkyl phosphate ester, which is acidic, is neutralized with an alkanolamine to form a salt. Alkanolamines that can be used for neutralization of the acidic phosphate ester include MEA (monoethanolamine), DEA (diethanolamine), and TEA (triethanolamine).

U.S. Pat. No. 8,309,503 of Fang, et al. discloses an external release for producing OSB panels that are employing pMDI as the adhesive. The external release agent reportedly allows for production of OSB at high temperature, without causing excessive press buildup and shortens press time. The waterborne external release agent composition comprises a mixture of: (a) a sodium salt of a fatty acid having at least 8 carbon atoms, b) a sodium salt of a phosphate ester having 8-12 carbon atoms, (c) an optional amount of an ethoxylated fatty alcohol surfactant having an alkyl chain length of 10-16 carbon atoms with from 3 to 12 ethylene oxide groups, and (d) the remaining balance being deionized water.

U.S. Pat. No. 8,882,898 of Fang, et. al. discloses an emulsified external release agent for use in manufacturing of wood composite products from wood fibers or chips with pMDI adhesives. The emulsified release agent provides effective release between the pressed wood product and the metal press surfaces, allows for production of wood products from wood fibers or chips at high temperature, without causing excessive press buildup. The emulsified release agent composition for use with a pMDI adhesive comprises an emulsified mixture of: (a) an alkali metal salt of a fatty acid having 8-18 carbon atoms, (b) an alkali metal salt of a phosphate ester that is derived from a non-ethoxylated fatty alcohol having 6-22 carbon atoms and having an HLB number of 4 or less, (c) an ethoxylated fatty alcohol having an alkyl chain length of 8-18 carbon atoms which serves as the emulsifying agent, (d) a preservative and, (e) the remaining balance by weight of deionized water. The compositions of this prior art are touted as providing good wood/metal platen release characteristics, but they do not address metal corrosion properties. The compositions are emulsions using a fatty alcohol ethoxylate as the emulsifier and it employs a non-ethoxylated phosphate ester as one of the release agents. There is no mention of the use of any ethoxylated fatty amines or of ethoxylated phosphate ester raw materials.

U.S. Pat. No. 9,120,827 of Block, et. al. discloses a release agent composition for use in the production of compact cellulose/isocyanate moldings via a compression molding process having improved surface finish characteristics. The release agent composition is comprised of a component (a) having at least one inorganic phosphate and at least one organic phosphate, a component (b) having at least one compound comprising at least two hydroxyl groups having a Mw of less than 250 g/mole, and a component (c) being an alkali metal hydroxide whereby the composition preferably has a mass ratio of component (a) to component (b) of from 20:80 to 80:20. Preferably the at least one inorganic phosphate comprises an alkali metal polyphosphate and/or an alkali metal mono-phosphate and the at least one organic phosphate comprises a dioleyl phosphate. Preferred compounds comprising at least two hydroxyl groups having a Mw of less than 250 g/mole include ethylene glycol, diethylene glycol, triethylene glycol, tetraethylene glycol, propylene glycol, butylene glycol, glycerol, trimethylolpropane, and pentaerythritol.

U.S. Pat. No. 9,303,113 of Grigsby, et. al. discloses the formation of ligno-cellulose composites by pressing a blended mixture of a particulate lignocellulose material with polymeric MDI (pMDI) resin in the presence of an ethoxylated fatty amine. The ethoxylated fatty amine is employed as an anti-masking agent to help reduce build-up on the platen surface. While the use of pMDI resins as a binder for ligno-cellulose composites provide many benefits some disadvantages associated with their use is binder adhesion to the platen and the associated accumulation of binder and binder reaction products (e.g., ureas and urethanes) on the press platen. This accumulation of residue on the press platen is the process of “masking” and it can negatively impact the surface quality of the pressed composite. The use of ethoxylated fatty amines when producing pMDI/wood composites was found to notably reduce the accumulation of binder and binder reaction products on the press platen over multiple press cycles and was claimed to be more effective in doing so than a conventional soap-based, external release agent from Valspar. The ethoxylated fatty amine, either neat or in solution, can be applied to either the ligno-cellulose composite substrate, to a pressing surface, or to both. The ethoxylated fatty amines that are useful in the claimed process are derived from primary amines having an alkyl group ranging in carbon chain length from C₈ to C₄₀ which have been ethoxylated to form tertiary fatty amine ethoxylates whereby the molar ratio of ethylene oxide to nitrogen in the fatty amine ethoxylate ranges from about 2 to about 50. A particularly preferred anti-masking agent were ethoxylated tallow amine compounds such as the 20 EO ethoxylate of tallow amine. The anti-masking agent in this process art may also be used in conjunction with other additives, treatments or both. If used, the additive(s) can be combined with the pMDI adhesive or added as a separate stream according to the teachings of this prior art but combining the additive(s) with an ethoxylated fatty amine within a waterborne release formulation is not disclosed. For example, internal and external release agent compositions or combinations of the two can be used in the composite making process so long as they do not interfere with the anti-masking benefits of the ethoxylated fatty amine but the releases are handled separately.

U.S. Pat. No. 11,345,122 of Barzegari, et. al. discloses the techniques for manufacturing heat and pressure cured composite articles containing a cellulosic material, a coupling agent, and a binder resin such as pMDI. The disclosed manufacturing methods are particularly focused on producing articles used as door skins, sometimes known as door facings, for the construction of doors. The coupling agent is believed to increase the hydrophilicity (wettability) of the lipophilic cellulosic material. One of the more preferred nonionic coupling agents, having an HLB value of about 7 to about 15, are ethoxylated alkylamines which are employed on the hydrophobic cellulosic material at a dosage level of about 0.1 wt. % to about 5.0 wt. %. In this cellulosic composite art, the ethoxylated alkylamines are therefore used as wetting agents.

U.S. Pat. No. 11,878,441 of Tchoukov, et. al. discloses a low corrosion external release agent for use in producing ligno-cellulose composite panels that employ pMDI as the binder. The waterborne, low corrosion external release agent that was disclosed comprises two or more anionic surfactants selected from the following groups:
a) an ethoxylated phosphate ester or a salt thereof consisting of mono-ester or di-ester species whereby the associated alkyl groups have a carbon chain length of C₆-C₃₀ and the average number of moles of ethylene oxide content are 1-20;
b) a non-ethoxylated alkyl phosphate ester or a salt thereof consisting of mono-ester or di-ester species whereby the associated alkyl groups have a carbon chain length of C₆-C₁₈;
c) an organic sulfur containing anionic surfactant, such as a sulfonate, sulfate or a disulfonate compound, or a salt thereof; and
   whereby an optional agent can also be used to adjust the formulation's finished pH, and the remaining balance of the formulation is water. The pH adjusting agent is used to preferably yield a finished formulation pH value of 6-10 and the agents can include alkali metal hydroxides, or amines but NaOH or KOH are most preferably used. The use of NaOH or KOH for pH adjustment will result in the formation of Na or K salts of the anionic surfactants listed above for formulary components (a), (b) and (c). The alkyl groups associated with the ethoxylated phosphate ester component (a) are preferably C₆-C₁₂ with an accompanying EO molar content of 1-12 while the alkyl groups associated with the alkyl phosphate ester component (b) are preferably a mixture of C₈ and C₁₄ alkyl phosphate esters. No specificity in regard to the type or quantitative amounts of suitable amines are disclosed in this prior art but given its intended function as a simple “pH adjuster” one skilled in the art would presume a small addition quantity of a low Mw amine species such as ammonium hydroxide or possibly an alkanolamine compound like AMP (aminomethyl propanol), MEA (monoethanolamine), DEA (diethanolamine) and TEA (triethanolamine), as previously taught in U.S. Pat. No. 5,744,079, would be the most likely amines used to adjust the composition's pH. Ethoxylated fatty amines are not disclosed as being suitable nor preferred amines.

It is also known to use phosphate ester, ethoxylated amines, or phosphate ester-amine salt compositions in end-use application areas other than making lignocellulosic products.

Phosphate-amine salt ionic compounds are disclosed in U.S. Pat. No. 5,354,484 and related subsequent patents for use as lubricants and anti-wear additives in machine and gear oils. However, it should be noted that such lubricating “phosphate-amine salt” compositions have preferably been produced from primary or secondary amine compounds and that the phosphate esters that are employed are non-ethoxylated mono-alkyl and di-alkyl phosphate esters. Similar phosphate-amine salt compounds are again disclosed as being a lubricant additive in a refrigerating machine fluid in U.S. Pat. No. 9,090,806. These non-aqueous lubricant end-use applications have no direct relevance to the field of making engineered wood composite products.

U.S. Pat. No. 3,931,043 discloses waterborne compositions for inhibiting the corrosion of metal components in which film forming aliphatic primary amines, such as octadecylamine, cocamine and hydrogenated tallow amine, are emulsified via the use of ethoxylated beta amines or ethoxylated beta diamines to yield corrosion-inhibiting fluids. The corrosion inhibition abilities of film forming aliphatic amines or of their salts is disclosed in this art and other patent art referenced therein. While this art suggests that certain aliphatic amines can yield corrosion inhibition benefits, the technical considerations therein do not take into account the potential for excessive film build-up on a metal platen (masking) nor the need for release properties as required in the field of making engineered wood composite products.

In U.S. Pat. No. 4,636,256 a water-soluble, corrosion inhibiting solution is disclosed that contains an ethoxylated, propoxylated alkylphenol amine, wherein the alkyl group contains about 5 to about 12 carbon atoms, and an acidic phosphate ester which are combined to form a salt that is effective in controlling sweet and sour corrosion of metal surfaces. Sweet corrosion and sour corrosion are two types of corrosion that commonly occur in the oil and gas industry. Sweet corrosion is a mild form of metal corrosion that occurs when carbon dioxide (CO₂) gas is present and is caused by water molecules saturating CO₂ gas or vice versa. It can cause pitting or material loss in steel tubing walls. Sour corrosion is a more severe form of corrosion that occurs when hydrogen sulfide (H₂S) gas is present and is caused by H₂S dissolving in water to form a weak acid. Sour corrosion can cause metal deterioration, pitting, and cracking. The general utility of various ethoxylated amines, derived from the ethoxylation of aliphatic amines, as film formers that yield corrosion inhibition properties in oil and gas pipelines is also discussed in Section 5.4 of the technical review article “Film Former Corrosion Inhibitors for Oil and Gas Pipelines-A Technical Review”; M. Askari, et. al., Journal of Natural Gas Science and Engineering. 58 (2018) pp. 92-114. This review indicates that ethoxylated amines have typically been used as auxiliary film-formers and as surfactants in inhibitor formulations. Similarly, the film forming behavior of alkyl phosphates esters onto iron surfaces in aqueous solution to yield protective films that mitigate corrosion are discussed in the technical publication entitled “Spontaneous formation of mono-n-butyl phosphate and mono-n-hexyl phosphate thin films on the iron surface in aqueous solution and their corrosion protection property”; C. Zhao, et. al., Royal Society of Chemistry Advances, 2015, 5, pp. 54420-54432. Again, none of the above art is directed to end-use application areas relevant to the field of making engineered wood composite products.

In US Application Publ. No. 20220226940 non-aqueous solder flux compositions are disclosed whereby the compositions comprise: (a) an acidic phosphate ester; and (b) an alkanolamine, or an ethoxylated amine. The solder flux compositions have excellent wettability, oxide removal capability, and good rheological characteristics for high-speed, pick-and-place manufacturing processes and can be made from a simple combination of two components, thereby avoiding the need for solvents, polymeric thickeners, and other components of traditional tacky solder fluxes. While combining an acidic phosphate ester and an ethoxylated amine is suggested in paragraph [0044] to form an ion pair (i.e., a phosphate ester-amine salt species) this non-aqueous formulation art and its end-use application have no direct relevance to the present invention. Furthermore, this art indicates that useful non-aqueous solder flux compositions comprise (a) 40 to 60 wt. % of acidic phosphate ester; and (b) 40 to 60 wt. % of ethoxylated amine. U.S. Pat. No. 5,322,554 of DeLong discloses an asphalt release agent composition and a method of applying the same, including a water-based solution of magnesium chloride and/or calcium chloride together with a phosphate ester corrosion inhibitor, an anionic surfactant as the foaming agent and a dye. The release agent is applied using a spray gun in combination with an air compressor to add air to foam the release agent. This art indicates that the phosphate ester functions as a passive corrosion inhibitor which acts by binding to the metal surface. This mode of protection is thus distinguishable from coating or film corrosion inhibitors and from scavenging corrosion inhibitors. In a preferred embodiment, the corrosion inhibitor is a pH-neutralized sodium phosphate ester. This prior art suggests that alkali metal phosphate esters can provide some corrosion inhibition benefits but this formulation or the end-use application area have no direct relevance to the field of making engineered wood composite products.

U.S. Pat. No. 5,380,466 discloses a method for inhibiting corrosion of metal surfaces in an aqueous medium whereby a water-soluble corrosion inhibitor is introduced in sufficient amounts that comprises a salt of a basic nitrogen compound and of an acidic phosphate ester compound. The acidic phosphate ester component is a mono-ester or di-ester phosphate ethoxylate or mixtures thereof whereby the amount of ethoxylation content can range from one to about 10 moles and the hydrocarbon portion can be an alkyl, aryl or an aralkyl group having from about 5 to about 15 carbon atoms. The basic nitrogen compound should be at least water dispersible and is an amine or amine derivative. Preferably the amine is a morpholine derivative having a N-alkylhydroxy group. However, other possible basic nitrogen compounds are morpholine, an amide, primary, secondary or tertiary amines, ammonia or the basic nitrogen compounds previously listed in U.S. Pat. No. 4,722,805 which includes oxazolines, tetrahydropyrimidines, imidazolines, pyrrolinediones, amino amides, monoamines such as rosin amine and alkoxylated rosin amine. While this prior art suggests that phosphate ester salts of amines can yield corrosion inhibition benefits it does not disclose the use of ethoxylated fatty amines, and the technical considerations therein do not consider the other performance factors (such as release and anti-masking) that are required in the field of making engineered wood composite products.

U.S. Pat. No. 6,471,905 discloses improved internal mold release agents based on various ammonium or metal salts of phosphoric acid esters, ammonium salts of carboxylic acids and/or ammonium or metal salts of sulfonic acids for producing cellular or compact, optionally glass fiber- and/or natural fiber-reinforced polyurethane moldings. The phosphate esters can be either mono-esters and/or di-esters of phosphoric acid having alkyl groups containing 1 to 10 carbon atoms and the associated ammonium group can be either an NH₄ group or a protonated alkyl amine species, which can be a primary, secondary or a tertiary alkyl amine, whose alkyl group(s) can contain 1 to 10 carbon atoms. Ethoxylated fatty amines are not employed in this release art nor is the application directed to producing ligno-cellulosic composites. The disclosed internal release compositions and their end-use application area therefore have no direct relevance to the field of making engineered wood composite products.

U.S. Pat. No. 6,506,795 discloses a waterborne, chromium-free wood preservative consisting essentially of 1 to 35% by weight of a mixture of 25 to 75 parts by weight of a fatty amine ethoxylate and 75 to 25 parts by weight of at least one member of the group consisting of an unsaturated fatty acid of 3 to 25 carbon atoms and their copper and zinc salts and the balance being water. It was found that the effectiveness of copper salt-based wood preservatives was no longer reduced by copper-resistant fungi when the disclosed compositions were employed. This wood preservative application for fatty amine ethoxylates has no direct relevance to the field of making engineered wood composite products.

Chinese Patent Publication CN 111771880A discloses an additive package for a sprayable water-based agricultural formulation for crops that contains a combination of fertilizer and pesticide components whereby the additive package helps to improve the formula's stability and helps to mitigate antagonistic chemical interactions between the fertilizer and pesticide components. The additive package utilizes a phosphate-based surfactant, a dispersant and a wetting agent. The phosphate-based surfactant is either an imidazoline-based phosphate or a phosphate ester ethoxylate derived from either a fatty alcohol ethoxylate or an alkylphenol ethoxylate. The wetting agent is chosen from fatty alcohol ethoxylates, alkylphenol ethoxylates and fatty amine ethoxylates while the dispersant is chosen from an alkyl phenyl ether sulfonate, an alkyl sulfonate, naphthalene sulfonate polycondensate, and lignin sulfonate. The additive composition comprises 30 to 80 parts by weight of phosphate ester surfactant, 1 to 10 parts by weight of dispersing agent, 1 to 10 parts by weight of wetting agent and the balance being water. So, the additive is predominantly phosphate ester surfactant whereby the phosphate-based surfactant to wetting agent (or more specifically the phosphate ester ethoxylate to fatty amine ethoxylate) weight/weight ratio ranges from 3/1 to 80/1. This agricultural related application wherein phosphate ester ethoxylates and fatty amine ethoxylates are both potentially used has no direct relevance to the field of making engineered wood composite products.

Chinese Patent Publication CN 116144416A discloses a non-aqueous formulation that is based on DOPT (dioctyl terephthalate) that is intended for use as a more biodegradable aluminum hot rolling liquid lubricant versus those that more commonly use mineral oil. The DOPT based formula shows good stability and the use of bactericides is reduced. The DOPT based formula employs numerous other organic chemical additives that are used in small quantities in the DOPT liquid base. Two of the small quantity additives employed in the overall formulation are an ethoxylated fatty amine, present in content amounts of 2% to 4% by weight, and an anionic surfactant (e.g., laureth phosphate which is a C₁₂ alkyl phosphate ester) in content amounts of 2% to 4% by weight. The utilization of these additives in a DOPT based liquid lubricant intended for use in an aluminum hot roll milling process has no direct relevance to the field of making engineered wood composite products.

### SUMMARY OF THE INVENTION

The present invention is directed to the creation and use of a waterborne external release agent for producing ligno-cellulose composites such as oriented strand board (OSB), particle board (PB) and medium density fiberboard (MDF), which employ isocyanate-based adhesives such as pMDI. The external release agent of the present invention is a water-based formulation that is easy to manufacture, has a very manageable Brookfield viscosity that is stable, it is readily pumped and transported and it also subsequently stable if further diluted with additional water for end-use spray application. With regards to the dilution water employed, the external release agent formulation of the present invention can tolerate the use of various water qualities ranging from deionized (DI) water, soft water, and to moderately hard water with minimal to no effect on release agent performance properties. The external release agent provides excellent release between the ligno-cellulose composite panels and the metal press platen surface thereby allowing high quality composite panels to be produced without causing excessive buildup of residues on the press (called masking in U.S. Pat. No. 9,303,113) or without promoting dark surface discoloration of the finished composite panels or without causing corrosion of the various carbon steel metal surfaces of the press. These end-use performance goals for the inventive external release are thus similar to those previously striven for in previous art, such as in U.S. Pat. No. 11,878,441 to Tchoukov, et al.; however, the technical approach taken to inhibit carbon steel metal corrosion and the combination of chemistries employed for the new inventive approach as described below are fundamentally different.

In Tchoukov, metal platen corrosion is attributed to the corrosive tendencies of the water itself given its dissolved oxygen content and to the exacerbated corrosive effects of the steam that is created and outgassed at high press temperatures. It is well known in the metal corrosion literature that steam can erode metals through a process called erosion-corrosion, whereby erosion can remove the protective metal oxide surface of the metal which can then speed up the process of electrochemical thinning, or corrosion (Part III: Corrosion in Water-Bearing Systems, Editors: Fuad Khoshnaw and Rolf Gubner, In Corrosion Atlas Series, Corrosion Atlas Case Studies, Elsevier, 2020, Pages lxix-lxxxiv). In some instances, it was suggested in Tchoukov that the release agents themselves, because of the presence of corrosive chemical components such as non-neutralized fatty acids present within soap-based release formulations or given the use of salts of ethylenediaminetetraacetic acid (EDTA) in the releases to mitigate water hardness, may also contribute to accelerated corrosion rates on the carbon steel surfaces that are commonly used in the press processes [column 2, lines 34-46]. While the aforementioned factors are undoubtedly contributors to steel metal corrosion in these press applications for making ligno-cellulose composites, there is another critical factor contributing to metal corrosion in these composite making processes which has gone unrecognized and thereby unaddressed. In short, experimental test findings suggest that many of the external release agent chemistries disclosed in the prior art and currently used in the engineered wood industry can penetrate the wood particles, fibers or strands and subsequently promote the liberation of the wood's organic “wood extractives” residing within the porous structure of the wood.

Wood as a substance is a composite mainly made up of three natural polymers (cellulose, hemicellulose and lignin) which comprise the cell wall and form most of the wood structure. Wood extractives, the extractable organic substances therein, represent about 2 to 5 percent of the composition of softwoods, 3 to 8 percent of temperate hardwoods, and up to 18 to 22 percent of tropical woods. Wood extractives are various organic compounds including waxes, fats, terpenes and terpenoids, fatty acids, monosaccharides, alkaloids, and phenolic compounds. These wood extractives can be removed and used for various commercial end use purposes, and on this basis, they have been classified into four chemical categories (N′Guessan, et. al., Forests Products Journal, Vol. 73, No. 3, 2023, pp. 194-208):
1) The first chemical category includes terpenes and terpenoids, and some of these extracts are also called gems. Terpenes are relatively volatile hydrocarbons based on isoprene units, and they are the major components of turpentine. The terpenoids comprise an important group of chemistries commonly known as resin acids. The resin acids, being the main components of rosin, are diterpenoids such as abietic acid, neoabietic acid, palustric acid, pimaric acid and isopimaric acid (T. Elder, Encyclopedia of Forest Sciences, USDA-Forest Service, 2004, pp. 607-612).
2) The second chemical category includes aliphatic compounds such as saturated and unsaturated fatty acids, alkanes, and fatty alcohols (e.g., triglyceride, palmitic acid, stearic acid). The various fatty acids in this fraction comprise what is commonly known as tall oil fatty acids when utilizing various softwood pine species.
3) A third chemical category concerns phenolic compounds. This large class includes simple phenols (vanillin), lignans (pinoresinol, hinokiresinol), flavonoids, tannins, and stilbenes.
4) The fourth chemical category is the alkaloids.

These organic wood extractives can be removed from the wood via various known extraction techniques, such as Soxhlet extraction with a suitable solvent. However, many of the organic compounds can also be removed by steam distillation whereby the applied heat is the primary cause of disrupting the cellular structure of the ligno-cellulose material thereby allowing the various organic compounds therein to be released. This steam extraction process suggests the internal steam that is being generated and outgassed during the high temperature pressing of an engineered wood composite can therefore transport various wood extractives to the surface of a wood panel and bring them in direct contact with the steel metal platens of the press.

Other wood-related academic studies (Yiqing Qi, et al., ACS Omega 2023, Vol. 8, No. 43, pp. 40362-40374) have shown that the permeability of various wood species can be notably increased when they are treated with alkali bases and heat. Utilizing a SEM to observe the microscopic structure of various wood species this study noted that after heating with an alkali base treatment, the wood vessels were opened up, the organic extractives were reduced, and resultant wood permeability was increased. It was also reported that color difference analysis of their wood species after alkali treatment indicated a notable decrease in the wood's surface brightness values. Other wood science investigators (such as Zanuncio, et al., Maderas-Ciencia y Technologia, 17 (4), 2015, pp. 857-864) have similarly reported the notable effect that wood extractives content can have on the color and brightness of heat-treated wood species. So, in summary, the application of heat and alkali chemical treatments can help increase wood permeability thereby liberating wood extractives that are carried to the surface which can then impact wood panel surface color, and the extractives can also come into direct contact with the pressing surface of the hot metal platens. Given the highly acidic nature of the various resin acids and fatty acids that reside in the wood extractives, one needs to account for the potential impact such acidic species could have on metal surface corrosion at the high press temperatures that are commonly in use in OSB mills (about 415° F.). For example, the reported pKa values for the acidic species originating from the lipophilic wood extractives of Pinus Radiata (also known as Monterey pine) can range from about 7 to about 10 for the various saturated and unsaturated fatty acids and from about 5.7 to about 7.6 for the various resin acids (D. Vercoe, PHD Thesis, School of Chemistry-University of Tasmania, 2005, Table 3.2, pp. 40-41). The pKa value is a number that describes how acidic a molecule is. It is calculated using the equation pka=−log [Ka] where Ka is the acid dissociation constant for a given chemical substance. A lower pKa value indicates a stronger acid, meaning the acid more readily dissociates in water and donates its protons. Being a base-10 logarithmic scale, an organic acid with a pka=6 is thus 10 times more acidic than an organic acid with a pKa=7. On this basis, one can surmise that the resin acids residing in the wood extractives are very acidic species that can pose a metal corrosion concern.

Considering the above factors that can promote the liberation of wood extractives that contain very acidic species, one should note that many of the external release agents in commercial use today are alkaline anionic surfactants consisting of alkali metal salts of either fatty acids or of acidic phosphate esters. The aqueous alkali metal fatty acid soap solutions, which are commonly pH 10.5-12.5, have been observed to be particularly detrimental to platen metal corrosion. This corrosive effect for the fatty acid soap chemistries that arises during the composite making process may not be solely attributable to the release chemistry's direct interaction with the metal platens but can likely be attributed to their high alkalinity, their hydrophilicity, their mostly linear geometric molecular shape, and their good surface tension reduction properties which collectively enable them to penetrate the wood pores and under heated conditions facilitate the liberation of the wood extractives which are subsequently transported to the surface of the wood panel via the evolved steam that is being generated during the press cycle. Metal platen corrosion may therefore be more a consequence of the applied release agent helping to liberate the wood extractives to a greater extent and the various acidic species within the wood extractives being subsequently brought to the surface by steam outgassing which then become major contributors for the observed metal corrosion effect. Consistent with this liberated and transported “wood extractives” hypothesis is that the high pH alkali metal fatty acid soaps often generate finished OSB panels with a darker surface coloration as the wood extractives brought to the surface of the panel are known to lower its surface brightness properties as measured by colorimetric “L” values in the tristimulus L-a-b color system.

Many of the alkali metal salts of phosphate esters can be less detrimental on platen metal corrosion than fatty acid alkali soaps because structurally the phosphate esters are a more bulky, branched molecule, given the presence of both mono-ester and di-ester phosphate species, and the fact that the molecular shape of phosphate esters is a tetrahedral geometric shape rather than one being essentially linear. The phosphate ester ethoxylates are an even bulkier species because of their ethylene oxide content. This structural branching and bulkiness likely make them less prone to penetrate the pores in the wood from a steric hindrance perspective. This steric hindrance hypothesis is supported by experimental data detailed below whereby the neutralized phosphate esters having a shorter alkyl chain and the neutralized phosphate esters having a greater mono-ester content were found to typically yield more metal corrosion in the press studies conducted than the corresponding phosphate esters having a longer alkyl chain length or having some degree of alkyl chain branching or having a greater di-ester content which is a more branched molecular species than the corresponding mono-ester. In general, the alkali metal salts of phosphate esters are also less alkaline in terms of their aqueous solution pH (with their pH's typically ranging from about 8.0 to about 9.5) than the commercial fatty acid alkali metal soaps whose solution pH values typically range from about 10.5 to about 12.5. These differences in solution pH are governed by differences in the respective pKa values of fatty acids versus those for acidic phosphate esters. As discussed above, alkalinity can play a role in helping to liberate wood extractives from the wood strands, fibers or particles. Lastly, some phosphate esters are known in the literature to function as a passive corrosion inhibitor by binding to the metal surface (as previously disclosed in U.S. Pat. No. 5,322,554) and some are known in aqueous solution to form protective films on iron surfaces which can effectively inhibit corrosion (C. Zhao, et. al., Royal Society of Chemistry Advances, 2015, 5, pp. 54420-54432). However, the innate ability of some phosphate esters to form protective films on metal surfaces can also be a negative issue if this film formation continues to the point of causing excessive build-up (masking) on the press platens over time. Excessive film buildup on the platens can lead to maintenance downtime in the mills for cleaning of the press platens.

With all the above factors in mind, the overall objective of the present invention is to create a waterborne external release agent composition which provides excellent release between the ligno-cellulose composite panel and the metal press platen surface thereby allowing high quality wood composite panels to be produced without causing excessive buildup of film residues on the press (masking) or without promoting dark surface discoloration of the finished engineered wood panels or without causing corrosion of the various metal surfaces of the press. All these end-use performance criteria for the external release agent should be simultaneously met even though some performance parameters can be diametrically opposed to one another (e.g., getting good corrosion resistance with some phosphate ester based releases but also getting excessive film buildup on the platens).

Beyond getting good release and inhibiting metal corrosion, the minimization of film build-up on the metal platens (also known as masking) is an important aspect of the inventive release formulations. Minimizing film build-up avoids costly shutdowns of the press for cleaning the surface of the platens and it also avoids the potential of adversely affecting heat transfer from the heated platens to the ligno-cellulose composite that is being pressed and cured. Heat not being efficiently transferred from the press platens to the board for curing the wood composite is, for example, a problem commonly experienced when employing silicone-based releases because of their film buildup issues on the platen and because of the thermal insulating properties of silicones.

One aspect of the current invention is to therefore employ a tertiary ethoxylated fatty amine as a component of the water-borne, low corrosion external release agent composition which serves a multi-functional role, as follows:
1. The tertiary ethoxylated fatty amine helps to inhibit excessive build-up (masking) on the metal platens and also helps to mitigate excessive film build-up for phosphate ester chemistries that have the ability to film form on the metal platen surface;
2. The applied tertiary ethoxylated fatty amine has the capability to adsorb onto the metal surface forming a hydrophobic protective film, which reduces the access of water and aggressive ions, that can help to retard corrosion as previously described in the literature (L. Genxian, et. al., Nuclear Engineering and Technology, 54, 2022, pp. 1185-1194) and, in addition, they have the capability to further mitigate metal platen corrosion by neutralizing any highly acidic wood extractive species that are transported to the surface of the composite wood panel by the internal steam that is being outgassed during the press cycle;
3. Given their bulky trigonal pyramidal geometric shape, the tertiary ethoxylated fatty amine molecules likely stay at the interface of the wood particle mat and the platen metal surface and do not penetrate down into the porous ligno-cellulose structure of the wood because of steric hindrance considerations. Steric hindrance is a term used in organic chemistry to describe how a molecule's physical structure can prevent or slow down chemical reactions or restrict their mobility into pores and cavities of a particular diameter size and/or shape. Steric hindrance occurs when the size and shape of a molecule's chemical groups hinder it from approaching other reactive chemistries. In the current application, the tertiary ethoxylated fatty amine is often too big and bulky in relation to the size of the wood substrate's pores to penetrate and interact with the internal cellular structure of the wood and the wood extractives. By staying at the wood mat/platen surface interface, the applied tertiary ethoxylated fatty amines provide the following.
   a. They may help to seal the surface of the wood mat thereby inhibiting the wood extractives from readily reaching the platen's metal surface. However, any acidic wood extractives that do make it to the surface interface are then neutralized given its amine functionality;
   b. They can form amine salts with acidic inorganic or acidic organic compounds and many of these tertiary ammonium salts can subsequently behave as good corrosion inhibitors at the metal surface. The formation of such tertiary ammonium salts of acidic phosphates or of carboxylic acids and their utility as corrosion inhibitors in various applications is known. This leaves open the possibility that other release chemistries having acidic groups might be purposely combined with the tertiary ethoxylated fatty amines to yield amine salt species that have dual functionality (i.e., release and corrosion inhibition).
   c. Being at the surface interface, they can provide some release properties between the wood composite that is being cured with isocyanate adhesive and the metal platen pressing surface although release is not the primary intended function of the tertiary ethoxylated fatty amine. The release characteristics of various tertiary ethoxylated fatty amines when producing particle board panels, in the absence of using any other internal or external release agents, is shown in Table VI of the experiments described below. Their overall release performance as free tertiary amines was only fair when used as standalone release agents.
4. It should also be noted that blends of more than one type of tertiary ethoxylated fatty amine can also be used as the organic amine component of the low corrosion, external release agent composition in order to take advantage of the specific performance advantages offered by different ethoxylated fatty amine chemistries.

To yield the multifunctional performance benefits described above, the tertiary ethoxylated fatty amine(s) used in the inventive external release formulation are compositionally represented by the formula depicted below

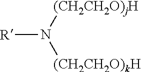

wherein R′=C₈-C₂₀ linear or branched, saturated or unsaturated aliphatic group, and the subscripts j+k=2-20 moles of ethylene oxide content on average. One particularly advantageous tertiary ethoxylated fatty amine is the one that is derived from coconut amine (also known as cocamine) whereby the average number of moles of ethylene oxide content arising from its subsequent ethoxylation totals 5; chemical nomenclature wise this product is known as PEG-5 cocamine. The properties and carbon chain length distribution of a typical commercial grade cocamine (e.g., ILCO MIN 8015 CD) are shown below in Table I.

TABLE I
Properties and Chain Length Distribution of Cocamine

| Parameter | Unit | Distilled Cocamine |
|---|---|---|
| Primary amine | [%] | min. 98 |
| Secondary amine | [%] | max. 1 |
| Amine number | [mgKOH/g] | min. 280 |
| Iodine number | [gI/100 g] | max. 12 |
| C-Chain Distribution | | |
| C8 | [%] | ~6 |
| C10 | [%] | ~6 |
| C12 | [%] | ~54 |
| C14 | [%] | ~18 |
| C16 | [%] | ~8 |
| C18 | [%] | ~8 |

Another aspect of the invention is to employ an acidic alkyl phosphate ester and/or an acidic phosphate ester ethoxylate, or combinations thereof, wherein both types of acidic phosphate ester compounds typically consist of a blend of mono-ester and di-ester phosphate species which are generically depicted below. Depending on the phosphorylation reagents employed, such as polyphosphoric acid or P₂O₅, the fatty alcohol or ethoxylated fatty alcohol starting materials can be respectively converted into alkyl phosphate esters or into phosphate ester ethoxylates having a mono-ester to di-ester molar ratio that typical ranges from about 90/10 to about 50/50. These acidic phosphate ester species are thereby employed as components of the water-borne, external release agent composition which serve a multi-functional role as discussed below.

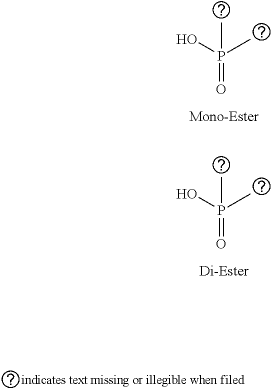

The acidic alkyl phosphate esters or the acidic phosphate ester ethoxylates can either be used alone in the inventive external release formulation or they can be used in combination with one another to yield the desired end-use performance benefits. Furthermore, more than one type of acidic alkyl phosphate ester or more than one type of acidic phosphate ester ethoxylate can be employed in these various phosphate ester blend combinations. In either case though, the various acidic phosphate ester species must be neutralized to a target pH using either a combination of an alkali metal base (like KOH) plus tertiary ethoxylated fatty amine or by employing a tertiary ethoxylated fatty amine alone as the sole base preferably in excess. These neutralization processes for the various phosphate ester species as used to formulate the inventive releases are graphically illustrated in FIGS. 1 and 2, respectively, and described in more detail below.

In the two step formulating process of FIG. 1, an acidic alkyl phosphate ester and/or an acidic phosphate ester ethoxylate is first partially neutralized with an alkali metal hydroxide base in water to a pH of about 8.5 to form an alkali metal salt species of the phosphate ester, whereafter the chosen tertiary ethoxylated fatty amine is then added in a particular weight ratio combination to yield a finished product formulation having a pH of about 9.0 to about 10.5 consisting of an equilibrium mixture of acidic phosphate ester, an alkali metal salt of the phosphate ester, and a tertiary ethoxylated fatty amine. The useful active basis weight ratio of phosphate ester, alkali metal salt species to ethoxylated fatty amine can range from about 5/95 to about 40/60.

In the one step formulating process of FIG. 2, the acidic alkyl phosphate ester and/or an acidic phosphate ester ethoxylate are combined with the tertiary ethoxylated fatty amine in water without the use of any alkali metal hydroxide base. This direct neutralization reaction between acidic phosphate ester and tertiary ethoxylated fatty amine results in an aqueous equilibrium mixture of acidic phosphate ester, tertiary ethoxylated fatty amine and a phosphate ester-amine ionic complex (i.e., a phosphate ester-ammonium salt species) whereby the nitrogen atom of the tertiary ethoxylated amine has been protonated to form a salt (see species F depicted in FIG. 2). The resultant pH of this equilibrium mixture ranges from about 6.0-8.5 depending on the weight ratio of acidic phosphate ester to tertiary ethoxylated fatty amine that is employed and depending on the total weight % actives of the batch. The useful active basis weight ratio of acidic phosphate ester to ethoxylated fatty amine can range from about 5/95 to about 40/60. As the total weight % actives content is increased, it is expected that the equilibrium concentration of the phosphate ester-amine ionic complex species should accordingly increase. It should also be noted that the proposed formation of such phosphate ester-amine ionic complex species can remain soluble in these aqueous release formulations given the hydrophilic nature of the ethoxylation segments within the associated ethoxylated fatty amine and within the phosphate ester ethoxylate potions of the ion complex so the waterborne formulations remain clear and homogeneous with no visible precipitation.

In the inventive external release formulations, the preferred phosphate ester species will provide the following multi-functional performance properties:
1. The phosphate ester species are principally responsible for providing the desired release properties between the ligno-cellulose composite that is formed and the metal press platen surface;
2. The phosphate ester species can function as a passive corrosion inhibitor by binding to the steel metal surface and they are also known in aqueous solution to form protective films on iron surfaces which can effectively inhibit corrosion. These are desirable corrosion inhibition properties if the overall extent of film formation can be moderated to some degree so that excessive film build-up on the platen does not become problematic as repetitive press cycles are conducted over extended production campaign periods. Test results indicate that some phosphate ester chemistries are more prone than others to yield excessive film build-up on the metal surface as is self-evident from the release and corrosion test data that is presented in the subsequent experimental section (see representative data found below in Tables IV, V, VII and VIII).
3. Phosphate esters are also known to offer high stability with respect to temperature and electrolytes over a wide pH range and, for this end-use release application, they provide an array of desirable surfactant properties such as emulsification, dispersing, wetting, lubrication, and solubilization.

To obtain the balance of performance properties desired for the inventive external release agents, the phosphate ester species that are selected must be done so mindful of the specific tertiary ethoxylated fatty amine chemistry that it is to be neutralized with and on what active basis weight/weight ratio amounts will be employed to yield a finished release formulation. Specific combinations of phosphate ester species and tertiary ethoxylated fatty amines work synergistically with one another to yield the overall balance of release plus corrosion inhibition versus film buildup performance properties desired while other combinations of phosphate ester species and tertiary ethoxylated fatty amines do not work very well together as seen in the test data presented in the subsequent experimental section below per Tables VII and VIII. The combinations that work synergistically versus those that do not work very well are not obvious or expected to an individual of ordinary skill in the art but had to be discovered through rigorous experimentation. Furthermore, the weight ratio range of acidic phosphate ester or of phosphate ester, alkali metal salt to tertiary ethoxylated fatty amine that is useful in the invention falls within an active basis weight ratio range of about 5/95 to about 40/60 with a more preferred weight ratio range being from about 10/90 to about 30/70 whereby the total actives content of the waterborne release formulation ranges from about 5% to about 50% by weight.

The total actives content range for the release formulations in weight % is largely dictated by their mixing process requirements, their resultant Brookfield viscosity and their shelf stability upon aging. As seen in FIG. 4 below, the viscosity profiles of two different release formulas as a function of their total actives content by weight % can differ significantly. The viscosity profile of the Expt. FFF formula variants as detailed below, which respectively employs a 10/90 weight ratio combination of iso-tridecyl phosphate and PEG-5 cocamine, that is produced via the one step, direct neutralization process of FIG. 2, exhibit an almost linear increase in Brookfield viscosity as its total actives content is increased. As a result, a total actives content of about 49% by wt. is possible to make as it yields a manageable initial Brookfield viscosity (as measured at 25° C. and at 100 rpm) of 387 cPs which subsequently ages at room temperature (about 22° C.) to 585 cPs after one week. However, at a total actives content equal to or greater than about 52% by weight the formulation forms a viscous gel upon aging. When one takes into account its viscosity changes as a function of temperature, it was subsequently determined that the optimum total actives content for that formula was about 37% by weight (see Table IX in Example 7 below). In contrast, when examining the viscosity profile of the Expt. HH formula variants shown in FIG. 4, which respectively employs a 28/72 weight ratio combination of PEG-4 oleyl ether phosphate (50/50 mono-ester to di-ester molar ratio) and PEG-5 cocamine, that is also produced via the one step, direct neutralization process of FIG. 2, the Expt. HH formula variants exhibit a more exponential-like viscosity response curve as a function of its total actives content by weight %. It can be readily produced at a total actives content of 37.0% by wt., which yielded an initial Brookfield viscosity (as measured at room temperature and 100 rpm) of 428 cPs, but pushing its total weight % actives content up higher results in an almost exponential increase in Brookfield viscosity wherein the mixing requirements become considerably more demanding.

In general, formulating the external releases of the present invention to achieve an initial Brookfield viscosity at room temperature less than about 500 cPs, as measured with a #2-4, preferably #3, disc spindle at 100 rpm, is a desirable product characteristic because it aids ease of formulation via the use of conventional impeller based mixing processes. Furthermore, if the finished formulation can maintain a Brookfield viscosity less than 500 cPs at 100 rpm after aging under different storage conditions ranging in temperature from 5° C. to 40° C., that is also very desirable as this lends to good pumpability properties and ease of use for preparing dilutions on site at the engineered wood mills. In the case where total actives contents of 5-15% by wt. are being produced those external releases would represent a “ready to use” release formulation that could be applied as supplied or it could be formulated on site at the wood mill at those actives level. When releases having a total actives content greater than 15% by weight, and more particularly those having at least 25% by weight or higher actives content, are being produced they are representative of concentrate release formulations that are designed to save shipping costs by minimizing the water content and they would then be subsequently diluted on site with water to the desired total actives content for end-use spray application at the engineered wood mill.

Another important aspect of the concentrate external release formulations is that they do not require the use of soft or deionized water for subsequent dilution or the utilization of chelating agent additives to mitigate hardness issues when employing various qualities of dilution water during their on-site dilution at the engineered wood mills. The elimination of chelating chemistries, such as tetrasodium ethylenediaminetetraacetic acid, therefore removes a known potential source of metal corrosion. The release formulation's overall tolerance to electrolytes is a property inherent to phosphate ester chemistries as discussed above.

With regards to formulating the inventive external releases, the preferred weight ratio of acidic phosphate ester(s) or phosphate ester, alkali metal salts to tertiary ethoxylated fatty amine(s) that is needed for yielding external releases that provide a high level of synergistic release performance across all the key criteria is highly dependent on the specific combination of acidic phosphate ester and tertiary ethoxylated fatty amine that is chosen and whether or not the acidic phosphate ester is neutralized with some alkali metal hydroxide base. For example, when employing a PEG-4 oleyl ether phosphate (with about a 50/50 molar ratio of mono- to di-ester species) in combination with PEG-5 cocamine via the one step, direct neutralization process of FIG. 2 (where no alkali metal hydroxide base is employed) the optimum active basis weight ratio of phosphate ester ethoxylate to tertiary ethoxylated fatty amine is about 28/72 (see release formula identified as Expt. HH in Table VIII below). In contrast, when employing an iso-tridecyl phosphate, which has no EO content, in combination with the PEG-5 cocamine via the one step, direct neutralization process depicted in FIG. 2, the optimum weight ratio of alkyl phosphate ester to tertiary ethoxylated fatty amine is respectively about 10/90 (see release formula identified as Expt. FFF in Table VIII below). These two illustrative external releases of the present invention both yield excellent release performance with no evidence of metal corrosion, with virtually no film build-up on the metal and no darkening of the ligno-cellulose composite surface. Some other preferred external release formulations produced in accordance with the direct neutralization process of FIG. 2 are as follows:
The Expt. HHH formula of Table VIII is an external release that employs a blend of different phosphate esters whereby a 25/75 wt. ratio of a C₈-C₁₀ alkyl phosphate to a PEG-4 oleyl ether phosphate (with about a 50:50 mole ratio of mono-ester to di-ester species) is respectively utilized and then collectively combined with a PEG-5 cocamine via the one step, direct neutralization process of FIG. 2. The combined total weight of the two different phosphate esters to the weight of the tertiary ethoxylated amine is optimally set at an active basis weight ratio of about 30/70, respectively, to yield an external release offering a good balance of release and corrosion resistance versus build-up properties.
The Expt. JJJ formula of Table VIII is an external release that also employs a blend of different phosphate esters whereby a 20/80 wt. ratio of a PEG-3 C₁₂-C₁₅ alkyl ether phosphate to a PEG-4 oleyl ether phosphate (with about a 50:50 mole ratio of mono-ester to di-ester species) is respectively utilized and then collectively combined with a PEG-5 cocamine via the one step, direct neutralization process of FIG. 2. The combined total weight of the two different phosphate ester ethoxylates to the weight of the tertiary ethoxylated amine is optimally set at a weight ratio of about 28/72, respectively, to yield an external release offering a good balance of release and corrosion resistance versus build-up properties.

As previously discussed, certain combinations of phosphate ester species and tertiary ethoxylated fatty amines can potentially result in the formation of a phosphate ester-amine ionic complex in aqueous solution whereby the acidic phosphate ester species protonates the nitrogen atom of the tertiary ethoxylated fatty amine to form a tertiary ammonium salt as depicted in FIG. 2 as species F. The presence and equilibrium concentration of such a phosphate ester-amine ionic complex and its subsequent deposition as a salt on the metal surfaces could play a key role in the balance of performance properties obtained with the inventive release formulations. The presence or formation of phosphate ester-amine salts have not been mentioned nor contemplated previously in the prior release art that is directed to producing ligno-cellulose composites that employ pMDI as the adhesive.

It should also be noted that the preferred active basis weight ratio of acidic phosphate ester to tertiary ethoxylated fatty amine can change slightly if the chosen acidic phosphate ester is first partially neutralized with an alkali metal hydroxide base to a pH of about 8.5. This point of difference is well illustrated when producing an external release composition using the PEG-4 oleyl ether phosphate chemistry (with 50/50 molar ratio of mono-ester to di-ester species) in combination with the PEG-5 cocamine wherein the phosphate ester ethoxylate was first partially neutralized with KOH to a pH of about 8.5 prior to the follow-up addition of the PEG-5 cocamine (see release formula of Expt. S in Table VII). The optimum active basis weight ratio of phosphate ester ethoxylate, potassium salt to PEG-5 cocamine in this instance is about 30/70, respectively, as compared to the 28/72 weight ratio noted above when the PEG-4 oleyl ether phosphate and PEG-5 cocamine were respectively combined in Expt. HH without the use of any KOH. In this instance, the overall release and corrosion versus build-up results for these two different neutralization approaches at their respective optimum weight ratios yielded very similar performance properties. Another preferred external release formulation produced in accordance with the two-step formulation process of FIG. 1 is as follows:
The Expt. DD formula of Table VII is a release formulation that employs a PEG-3 isotridecyl ether phosphate which was partially neutralized with KOH in accordance with the formulation process of FIG. 1 and then subsequently combined with a PEG-5 cocamine. The weight of phosphate ester ethoxylate, potassium salt to the weight of the tertiary ethoxylated fatty amine is optimally set at a weight ratio of 26/74, respectively, to yield an external release offering a good balance of release and corrosion resistance versus build-up properties. It is interesting to comparatively note that the corresponding release formulation, Expt. SS of Table VIII, which uses the exact same phosphate ester ethoxylate and ethoxylated fatty amine chemistries at the same weight ratio combination (i.e., 26/74) but combined in accordance with the one step formulating process of FIG. 2, where no partial KOH neutralization was employed, did not perform as well with respect to its corrosion resistance properties. This outcome suggests that the phosphate ester ethoxylate to tertiary ethoxylated fatty amine weight ratio composition needs to be adjusted in the direct neutralization process per FIG. 2 to achieve a better balance of external release performance properties. This finding further confirms that the optimal weight ratio for a given combination of acidic phosphate ester and ethoxylated fatty amine will typically differ depending on which neutralization process is employed (the process of FIG. 1 or of FIG. 2).

Another important consideration in selecting a given acidic alkyl phosphate ester or acidic phosphate ester ethoxylate for use in the inventive release formulations is the impact its mono-ester to di-ester molar ratio content can have on resultant release and corrosion inhibition versus build-up performance. The mono-ester and di-ester phosphates are both useful in the current invention, with either one used alone or in various blend ratio combinations yielding useful functional performance benefits. However, commercially available acidic phosphate esters typically contain a blend of mono-ester and di-ester species whereby the mole ratio of mono-ester to di-ester content commonly ranges from about 90:10 to about 50:50, respectively, depending on what phosphorylation reagent was used in its synthesis. The amount of impact on release performance as function of the mono-ester to di-ester mole ratio is also very dependent on the specific combination of acidic phosphate ester and ethoxylated fatty amine chemistry that is chosen. For example, when utilizing a PEG-4 oleyl ether phosphate that has been first partially neutralized with KOH to a pH of about 8.5 and then combined with a PEG-5 cocamine at a phosphate ester, potassium salt to ethoxylated fatty amine weight ratio of 30/70, respectively, the release formulation using the phosphate ester ethoxylate compound having a mono-ester to di-ester mole ratio of about 50/50 (per Expt. S) versus using one employing the analogous phosphate ester ethoxylate having a mono-ester to di-ester mole ratio of about 80/20 (per Expt. U) the former composition was found to well protect the metal from corrosion while better minimizing residual film buildup on the metal whereas both molar ratios of mono-ester to di-ester yielded formulations providing nearly equivalent release performance (compare the respective performances of the Expt. S and Expt. U formulas in Table VII). In another instance, the release performance of two analogous release formulations both produced by the one step, neutralization process of FIG. 2, were compared. Release performance was found to be notably lowered from a release rating of 3.0 to 2.0 while the amount of accompanying film build-up on the metal was notably increased when the composition of the external release formulation was altered from one using a PEG-4 oleyl ether phosphate having a 50/50 mole ratio of mono-ester to di-ester to one using the analogous phosphate ester having a mole ratio of about 80/20 (compare the respective performances of the Expt. GG and Expt. JJ formulas in Table VIII which both employed an acidic phosphate ester ethoxylate to ethoxylated fatty amine weight ratio of 26/74). It is also interesting to note that in both cases discussed above, the amount of film build-up on the metal shim was increased to a greater degree when an acidic phosphate ester ethoxylate having a higher mono-ester content was employed in the release formulation. The same performance trends were also observed when comparing the release formulas of Expt. EE-1 and Expt. EE-2 in Table VII which employed C₈-C₁₀ alkyl phosphates having a different mole ratio of mono-ester to di-ester species. Without being bound to a particular theoretical explanation, the creation of more film deposition on the metal shims when alkyl phosphate esters or phosphate ester ethoxylates having a greater mono-ester content are used suggests that the mono-ester species may be prone to some self-polymerization into polyphosphoesters or the extra P—OH group that is present in phosphate monoesters may undergo a reaction with the isocyanate groups from the pMDI adhesive resin to form a urethane linkage with the phosphate ester molecule.

In another aspect of the invention, the acidic alkyl phosphate ester(s) and/or the acidic phosphate ester ethoxylate(s) used in the inventive external release formulation are compositionally represented by the formula depicted below

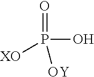

whereby the acidic phosphate ester can be either an alkyl phosphate ester or a phosphate ester ethoxylate or combinations of the two types whereby these acidic phosphate esters are typically a mixture of mono-ester and di-ester species that can compositionally range in mono-ester to di-ester mole ratio content from about 90/10 to about 50/50. In addition, combinations of different acidic alkyl phosphate esters can be employed or combinations of different acidic phosphate ester ethoxylates can also be employed in the inventive release formulations. So, in summary, the external release agent employs phosphate ester chemistry components whereby:
a) one or more alkyl phosphate esters can be employed;
b) one or more phosphate ester ethoxylates can be employed;
c) combinations of types a and b can be employed;
d) the above categories of phosphate ester (a thru c) can each be utilized in combination with an ethoxylated fatty amine or they can be partially neutralized with an alkali metal hydroxide base to a pH of about 8.5 before combining them with a tertiary ethoxylated fatty amine;
e) all of the above categories (a, b, c and d) can contain both mono-ester and di-ester phosphate species.

In reference to the above depicted formula, the acidic alkyl phosphate esters that are useful in the inventive external release formulation are those derived from fatty alcohol feedstocks whereby:
X=C₆-C₁₄ aliphatic carbon chain (either linear or branched);
Y=H or C₆-C₁₄ aliphatic carbon chain (either linear or branched).
   The acidic phosphate ester ethoxylates that are useful in the inventive external release formulation are those derived from ethoxylated fatty alcohol feedstocks whereby:
X=—(CH₂CH₂O)_{z}—R where R=a C₆-C₂₀ aliphatic carbon chain (linear or branched; saturated or unsaturated) and z=2-10 units of ethylene oxide content;
Y=H or —(CH₂CH₂O)_{z}—R where R=a C₆-C₂₀ aliphatic carbon chain (linear or branched; saturated or unsaturated) and z=2-10 units of ethylene oxide content.

In another aspect of the invention, the external release formulation can contain an optional defoamer additive that is used to reduce process foam during its production or is used to reduce foam levels in the diluted release agent solution that is to be applied for yielding ligno-cellulose composite/metal platen release. A particularly preferred defoamer for use in the inventive releases is Munzing's DEE FO PG-20, which can be employed at levels up to 0.3% by weight of the total formulation weight. The DEE FO PG-20 is a very effective defoamer additive, but it can in some instances provide some additional boost in release performance given its siloxane related composition. It is generically described in its product literature as a blend of 3-dimensional siloxane and polyoxyalkylene technology.

Another aspect of the invention entails the use of an optional nonionic surfactant in the external release agent formulation whereby a nonionic surfactant additive having an HLB (hydrophilic lipophilic balance) value of about 3-16 can also be employed, if needed, to improve wetting, reduce formulation viscosity and/or to serve as a hydrotrope to help solubilize the other principal components. They can be used in amounts up to 3.0% by wt. of the total actives content, which is the combined weight of phosphate ester(s) plus ethoxylated fatty amine(s) plus optional defoamer in the formulation, so long as the nonionic surfactant addition has no deleterious effect on the resultant release, build-up or metal corrosion performance properties of the external release formulation. A few illustrative examples of some useful nonionic surfactants are Polypropylene Glycol (9) (average Mw=400; HLB=9.8), Poloxamer 184 (EO/PO block copolymer; average Mw=about 2,900; HLB=15.0), Poloxamer 182 (EO/PO block copolymer; average Mw=about 2500; HLB=7.0) and Poloxamer 181 (EO/PO block copolymer; average Mw=about 2,000; HLB=3.0). For example, in a high total actives content release formulation employing a 28/72 w/w combination of PEG-4 oleyl ether phosphate and PEG-5 cocamine the use of small quantities of Poloxamer 181 were seen to reduce the Brookfield viscosity (as measured at room temperature and 100 rpm) by as much as 15-20%. When adding a nonionic surfactant was beneficial, it was interesting to note that EO/PO block copolymer surfactants were often found to be more effective in reducing release formulation viscosity than a traditional ethoxylated fatty alcohol surfactant, such as a PEG-6 or a PEG-9 decyl alcohol surfactant, which have HLB values equal to 12.4 and 14.3, respectively. In contrast, for another high total actives content release formulation employing a 10/90 w/w combination of iso-tridecyl phosphate and PEG-5 cocamine, the use of any nonionic surfactant was found to be totally ineffective in reducing the formulation's Brookfield viscosity. So, in conclusion, using a nonionic surfactant is optional and the benefits of addition are dependent on the specific external release formulation of interest.

In another aspect of the invention, there is provided a method for applying an external release agent to a ligno-cellulose fiber, chip, strand or particle mat or to the metal surface of a press used in the manufacturing of engineered wood composite products that employ an isocyanate-based adhesive, such as pMDI. The method can include the following steps.
1) Providing the water-borne external release agent derived from combining one or more acidic phosphate ester chemistries, that consists of one or more acidic alkyl phosphate esters (as compositionally defined above) or consists of one of more acidic phosphate ester ethoxylates (as compositionally defined above) or consists of a combined blend of these acidic alkyl phosphate esters plus acidic phosphate ester ethoxylates, with one or more tertiary ethoxylated fatty amines (as compositionally defined above) whereby the acidic phosphate ester(s) plus ethoxylated fatty amine(s) are combined in water in accordance with either the two step formulation process depicted in FIG. 1 or the direct neutralization process depicted in FIG. 2. The combination of acidic phosphate ester(s) plus ethoxylated fatty amine(s) that is employed, using either the formulation process of FIG. 1 or FIG. 2, compositionally ranges from a total phosphate ester or phosphate ester, alkali metal salt to total ethoxylated fatty amine active basis weight ratio of about 5/95 to about 40/60, respectively, or more preferably from about 10/90 to about 30/70 wherein the acidic phosphate esters being employed are a blend of mono-ester and di-ester species typically falling within a mono-ester to di-ester mole ratio range of about 90/10 to about 50/50, respectively. The external release formulation can optionally contain other minor additives in it such as a defoamer additive (in amounts up to 0.3% by wt. of the total formulation weight) or an optional nonionic surfactant having an HLB value of 3-16 in amounts up to 3.0% by wt. of the total actives content (which is the combined weight amounts of the phosphate ester(s) or phosphate ester, alkali metal salt(s) plus ethoxylated fatty amine(s) plus optional defoamer) whereby the total actives content of the complete release formulation ranges from about 5.0-50.0% by weight.
2) Then transferring the external release agent formulation of step 1 into an application system at the engineered wood mill whereby the total actives content of the formulation is subsequently diluted with water as needed to sufficiently reduce its Brookfield viscosity for providing a uniform distribution of release agent. For atomized spray application onto a ligno-cellulose mat, the total actives content of the external release formulation that is applied commonly ranges from about 5.0-15.0% by weight and will ideally have a Brookfield viscosity (as measured at 25° C. and 100 rpm) of 75 cPs or less.
3) Then thereafter applying an effective amount of the external release agent to a ligno-cellulosic fiber, chip, strand or particle mat (or combinations of these ligno-cellulose materials) or to the metal surface of a press or to both the mat and metal surfaces using said application system prior to forming the pressed ligno-cellulose composite. An effective active basis amount of the external release agent to be applied to the surface of the ligno-cellulose mat or to the metal surface of a press or to both surfaces can range from about 0.1 dg/sq. ft. to about 2.0 dg/sq. ft. per surface, but more commonly ranges from about 0.25 dg/sq. ft. to about 1.5 dg/sq. ft. whereby the dg unit denotes “dry gram basis”. In addition, the metal pressing surface can be initially primed with the external release agent of the present invention before beginning a production campaign to make a ligno-cellulose composite and the external release agent of the present invention can also be utilized in combination with various internal release agents known in the prior art, such as waxes, so long as the internal release chemistries do not interfere with any of its multi-functional performance characteristics as discussed above.

The inventive formulation described above as well as its use in the making of engineered wood composite products is further described below in its broadest embodiments in terms of the formulation makeup and its use for improving release, inhibiting corrosion and reducing masking when making the engineered wood composite products.

In this embodiment of the invention, a release agent and corrosion inhibitor formulation that also yields minimal film buildup on the press surface, preferably for use in producing ligno-cellulosic composites comprises:
at least one tertiary ethoxylated fatty amine having formula (I)

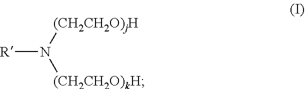

wherein R′=C₈-C₂₀ linear or branched, saturated or unsaturated aliphatic group, and subscripts j+k=2-20 moles of ethylene oxide content on average, and
at least one of an acidic alkyl phosphate ester and an acidic phosphate ester ethoxylate, or combinations thereof, having formula (II)

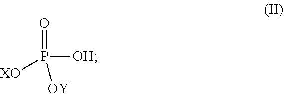

wherein X=C₆-C₁₄ aliphatic carbon chain (either linear or branched) and
Y=H or C₆-C₁₄ aliphatic carbon chain (either linear or branched) for the acidic alkyl phosphate ester; and
wherein X=—(CH₂CH₂O)_{z}—R where R=a C₆-C₂₀ aliphatic carbon chain (linear or branched; saturated or unsaturated) and z=2-10 units of ethylene oxide content and Y=H or —(CH₂CH₂O)_{z}—R where R=a C₆-C₂₀ aliphatic carbon chain (linear or branched; saturated or unsaturated) and z=2-10 units of ethylene oxide content, for the acidic phosphate ester ethoxylate; and
water;
wherein an active basis weight ratio of the at least one of an acidic alkyl phosphate ester and an acidic phosphate ester ethoxylate or combination thereof to the at least one tertiary ethoxylated fatty amine ranges between about 5/95 to about 60/40, preferably between about 10/90 and about 30/70; and
wherein a total actives content of the formulation ranges between about 5 and about 50% by weight of the total formulation, the balance being water.

The formulation can include a defoamer in an effective amount to reduce process foam when making the formulation or diluting the formulation. Preferably, the effective amount of the defoamer is between zero and up to 0.3% by weight of the total formulation.

The formulation can also include an effective amount of a nonionic surfactant having an HLB (hydrophilic lipophilic balance) value of about 3 to about 16 to improve wetting, reduce formulation viscosity and/or to serve as a hydrotrope to improve solubility. Preferably, the effective amount of the nonionic surfactant is up to 3.0% by weight of the total actives content.

The formulation can also include both the defoamer and the nonionic surfactant if so desired.

As noted above, the formulation could include one or more acidic alkyl phosphate esters or one or more acidic phosphate ester ethoxylates or combinations thereof.

The at least one tertiary ethoxylated fatty amine can be selected from the group consisting of PEG-5 cocamine, 75/25 w/w of PEG-5 cocamine to PEG-2 cocamine, PEG-10 cocamine, PEG-15 cocamine, and PEG-10 tallowamine. The at least one acidic alkyl phosphate ester can be selected from the group consisting of C₈-C₁₀ alkyl phosphate, 2-ethylhexyl phosphate, C₁₂-C₁₄ alkyl phosphate, hexyl phosphate, and iso-tridecyl phosphate. The at least one acidic phosphate ester ethoxylate can be selected from the group consisting of PEG-4 oleyl ether phosphate (50/50 mono/di), PEG-4 oleyl ether phosphate (80/20 mono/di), PEG-2 2-ethylhexyl ether phosphate, PEG-3 C₁₂-C₁₅ alkyl ether phosphate, PEG-2 C₁₂-C₁₄ alkyl ether phosphate, PEG-3 C₁₂-C₁₄ alkyl ether phosphate, PEG-4 C₁₂-C₁₄ alkyl ether phosphate, and PEG-3 iso-C₁₃ alkyl ether phosphate. The combination of the at least one of an acidic alkyl phosphate ester and the acidic phosphate ester ethoxylate can be selected from the group consisting of 15/85 w/w hexyl phosphate to PEG-4 oleyl ether phosphate, 25/75 w/w C₈-C₁₀ alkyl phosphate to PEG-4 oleyl ether phosphate, 20/80 w/w iso-tridecyl phosphate to PEG-4 oleyl ether phosphate; and 20/80 w/w PEG-3 C₁₂-C₁₅ alkyl ether phosphate to PEG-4 oleyl ether phosphate.

In a more preferred embodiment, the at least one tertiary ethoxylated fatty amine is PEG-cocamine (Ethox CAM-5) and the at least one of an acidic alkyl phosphate ester and an acidic phosphate ester ethoxylate, or combinations thereof is PEG-4 oleyl ether phosphate having 50/50 molar ratio of mono-ester to di-ester (Ethfac 140). This combination of phosphate ester ethoxylate and ethoxylated fatty amine is particularly effective as an external release when the PEG-4 oleyl ether phosphate and the PEG-5 cocamine are respectively used in an active basis w/w ratio of 28/72.

In another preferred embodiment, the at least one tertiary ethoxylated fatty amine is PEG-cocamine (Ethox CAM-5) and the at least one of an acidic alkyl phosphate ester and an acidic phosphate ester ethoxylate, or combinations thereof is iso-tridecyl phosphate (Ethfac 103). This combination of alkyl phosphate ester and ethoxylated fatty amine is particularly effective as an external release when the iso-tridecyl phosphate and the PEG-5 cocamine are respectively used in an active basis w/w ratio of 10/90.

The inventive formulation can include an effective amount of phosphate ester amine salt for corrosion inhibition when the formulation is made without the use of the partial neutralizing step of FIG. 1.

Preferably, the formulation has an initial Brookfield viscosity, as measured at 25° C. using a #2-4 disc spindle at 100 RPM, of less than 500 cPs, and an aged viscosity as measured using a #2-4 disc spindle at 100 RPM, measured over 1 to 3 weeks and at temperatures ranging from 5 to 40° C., of less than 500 cPs.

Due to the nature of the active ingredients of the formulation, the water used for the formulation does not have to be softened or sourced as deionized water.

The formulation can also include an alkali metal salt species of the at least one of an acidic alkyl phosphate ester and an acidic phosphate ester ethoxylate, or combinations thereof, the formulation having a pH falling between about 9.0 and about 10.5 as measured at 25° C. This is a result of making the inventive formulation using the process scheme of FIG. 1.

Besides providing an improved release agent and corrosion inhibitor which yields minimal film buildup on the press surface, ideally for use in making ligno-cellulosic wood products, the invention also includes the method of using the inventive formulation when making such products.

In one aspect of the method of use, the inventive formulation is provided as a release agent for a mat made of a lignocellulosic fiber, chip, strand, or particle and/or a metal surface of a metal platen used in the manufacture of engineered wood composite products. An effective amount of the formulation can be applied to the mat and/or the metal surface to improve release between the mat and the metal surface, inhibit corrosion of the metal surface, and reduce buildup on the metal surface.

When the formulation is used for making engineered wood composite products, it is preferred that the formulation is used with a total actives content ranging between about 5 and 15 wt. %. Higher actives content weight percentages are desirable when shipping a more concentrated formulation to a facility for engineered wood composite product making to save on shipping costs.

While the formulation can be applied to either the mat or the metal surface, it is preferred that the formulation be applied to both the mat and the metal surface. When the formulation is applied to the metal surface or mat, a preferred application dosage level is between about 0.1 dg/sq. ft. and about 2.0 dg/sq. ft., wherein dg denotes dry gram basis and sq. ft. applies to surface area of the mat or metal surface. A more preferred application dosage level is between about 0.25 dg/sq. ft. and about 1.5 dg/sq. ft.

While the inventive formulation can be used in connection with making any type of engineered wood composite product, it is preferred to use the formulation on wood mats that utilize an isocyanate-based adhesive since these adhesives are more prone to cause release problems, buildup on the metal surface and corrosion issues arising from the need to use a release agent to overcome the associated sticking issues. The wood mats can also include the use of internal release agents such as a wax which are typically added as a wax emulsion.

Another aspect of the method of making the engineered wood composite product wherein the mat is formed into an engineered wood composite product using a heated metal pressing surface and the inventive formulation, the formulation reduces transport of acidic wood extractives species in the mat to an interface between the mat and the metal pressing surface and assists in neutralizing acidic wood extractive species that exist in the interface as a result of reaction with the at least one tertiary ethoxylated fatty amine of the formulation.

### BRIEF DESCRIPTION OF THE DRAWINGS

FIG. 1 shows a two-step process of making the inventive formulation, where a alkali metal hydroxide base is used to partially neutralize the phosphate ester component of the formulation followed by the step of adding the ethoxylated fatty amine component of the formulation to the partially neutralized alkali metal salt species.

FIG. 2 shows a one step process of making the inventive formulation, wherein the phosphate ester and the ethoxylated fatty amine components of the formulation are added together without the use of any alkali metal hydroxide base. The direct reaction between the acidic phosphate ester component and the basic ethoxylated fatty amine component can result in the formation of a phosphate-amine ionic complex.

FIG. 3A shows a micrograph figure of a control test shim before subjecting it to pressing.

FIG. 3B shows a micrograph of a test shim after pressing and cleaning using a prior art release agent.

FIG. 3C shows a test shim after pressing and cleaning using one embodiment of the inventive release formulation.

FIG. 4 is a graph comparing viscosity profiles for two different inventive release formulations based on total actives wt. % and their initial Brookfield viscosity at 25° C.

### DETAILED DESCRIPTION OF THE INVENTION

As described above, the present invention is directed to the creation and use of a waterborne external release agent for producing ligno-cellulose composites such as Oriented Strand Board (OSB), Particle Board (PB) and Medium Density Fiberboard (MDF), which employ isocyanate-based adhesives such as pMDI. The external release agent of the present invention is a water-based formulation that is easy to manufacture, has a very manageable Brookfield viscosity that is stable, it is readily pumped and transported and it also subsequently stable if further diluted with additional water for end-use spray application. The inventive formulation combines at least one tertiary ethoxylated fatty amine with at least one of an acidic alkyl phosphate ester and an acidic phosphate ester ethoxylate, or combinations thereof, as a waterborne formulation that provides unexpected benefits by providing improved release properties, improved corrosion inhibition, and improved anti-masking properties in one formulation. While it is known that other prior art agents that are used to make engineered wood composite products may provide improvements in one of release properties, corrosion inhibitor, or anti-masking properties. However, these known agents may provide improved release properties but are detrimental to corrosion or inhibit corrosion but provide poor release properties or cause masking of the metal platens used to make the engineered wood composite products. Only the inventive formulation provides improvements in all three of these areas simultaneously such that the trade-off in properties resulting from the use of prior art agents is avoided.

In order to demonstrate the advantages associated with the inventive formulation, a number of experiments were conducted the performance of the inventive formulation and prior art agents were compared in terms of release properties, anti-masking properties and corrosion inhibition.

The following section first provides details of the experimental methods used in establishing criteria for measuring the performance of prior art formulations and the inventive formulation in terms of release characteristics, measuring build up and/or metal loss on test shims used in the experiments, and properties associated with the formulation in terms of Brookfield viscosity, % actives content by weight determination, pH, and specific gravity, e.g. criteria used to measure the quality control performance of the prior art and inventive release formulations when used to make engineered wood composite products. This section is then followed by details of the conducted experiments as Examples 1-8.

### Experimental Methods and Criteria

### Release Testing

The release performance of several commercial external release agents for ligno-cellulose composites and for various experimental release agents were comparatively tested below using the following testing methodology:
Release performance was quantified using particle board “face wood” particles by applying Covestro's Mondur 541 pMDI adhesive at a 7% wt. basis (to dry wood w/w) using a blender. A particle board “face wood” composite was pressed employing this high pMDI adhesive level while also utilizing a low applied release agent amount (0.50 dg/sq. ft.). This testing protocol was intentionally developed and adopted as a stress test for assessing differences in release agent release performance. Previous commercial experience has indicated that external release agents that yield good release characteristics under these strenuous test conditions will perform very well across a wide array of different ligno-cellulose composites employing more typical commercial adhesive levels and press conditions.
Release performance was determined by a two-fold assessment protocol using a single low-carbon steel metal shim that was 6″×4″×0.01″ in size that was placed in the middle of the PB face wood pile.
   In one aspect of the release assessment a release rating scale is utilized that entails a manual assessment of how readily the metal test shim will release from the pressed composite with minimal assistance or how tenaciously it remains stuck to the pressed composite while physically facilitating its removal using a putty knife around the edges of the shim. In addition, the number and approximate size of wood particles adhered to the metal shim once it is removed from the composite surface is visually determined and these criteria are factored into the overall release rating. The release rating assessment criteria employed in this testing are defined in Table II.
   In another aspect of the release assessment the amount of pickup of wood plus resin onto the metal shim is quantified by the shim's total net weight gain, in mg quantities, by using a four decimal place Ohaus analytical balance. The amount of total net weight gain was determined after the completion of 4 press cycles. Lower amounts of net weight gain are therefore indicative of better release performance efficacy. These values are reported in the following Tables associated with the illustrative examples.
The low-carbon steel metal shim material that was employed in the release testing was cut from PRECISION BRAND shim stock sheet, Mfr #16870, which is a cold rolled flat sheet that is 0.01″ in thickness produced from 1008-1010 grade low carbon steel. The 4″×6″ test shim coupon to be used in the testing is cleaned with IPA (isopropanol) solvent to remove any protective oils then pre-weighed before use to get a precise tare weight for the clean virgin shim. A typical starting 4″×6″×0.01″ test shim coupon weighs about 31.0±1.0 g.
After the PB face wood particles are blended with the pMDI resin at loading of 7% active basis wt. (to dry wood w/w) a wood pile is hand formed employing a square frame that was 13.5″×13.5″ in internal size. The wood pile was prepared on a 14-gauge 15″×15″ mild steel A1011 plate in order to produce a final pressed board target thickness of about ¼″ and a finished board density of about 48 lbs./cu. ft. For the sake of testing time and reducing the amount of raw materials consumed, particle boards of greater thickness, like 0.75″, which are more typical of commercial PB products were not produced since we were just interested in the surface release properties.
The external release agents to be tested were all reduced in actives weight content to 10.0% using the appropriate amount of 40 ppm hardness dilution water and then spray applied onto the top of the PB face wood pile using an aerosol assisted PREVAL Sprayer unit equipped with a trigger spray head. The 10.0 wt. % active release agent was uniformly applied across the wood pile at a target active basis application level of 0.50 dg/sq. ft. The clean low-carbon steel shim coupon (6″×4″×0.01″), which has been surface primed with a layer of release that's baked on before initial use, was placed on top in the middle of the wood pile, then another 14-gauge mild steel A1011 plate was placed on top of it and the entire assembly of bottom steel plate/wood pile/test shim/top steel plate was pressed using an 18″×18″ Wabash electrically heated press unit for 61 seconds heated at 325° F. using 10-13 tons of applied pressure with bump assist. This test process protocol was repeated four times.
   Before use, the top face of the bottom mild steel plate was also primed with the same 10.0 wt. % active release agent solution at an active basis application level of about 0.2 dg/sq. ft. before use. Release agent application to the bottom plate was done to prevent the cured composite from sticking to the bottom steel plate and this plate was re-primed before each press cycle.
After a press step is completed, the metal test shim coupon is removed from the cured wood composite surface and the net weight gain was determined by re-weighing the coupon on the analytical balance. In total four separate PB composites were produced whereby the 10.0 wt. % active release agent was applied to the fresh PB face wood pile each time and each was subsequently pressed using the same plate/test shim assembly and Wabash press conditions as detailed above. In addition, the press cycles were all performed on the same test side of the metal shim coupon for a given release agent so the effective net weight gains would be cumulative over the four press runs conducted.

TABLE II
Release Rating Test Criteria

| Release Rating | |
|---|---|
| Numerical | |
| Value | Release Rating Description |
| (0 → 4 Scale) | (Release Characteristics from Face Wood based Particle Board) |
| 4.0 | Metal shim self-released during all 4 press cycles with no manual assistance with a |
| “Excellent | scrapping tool or putty knife required to yield its release from the underlying |
| Release” | compressed wood panel. Any uptake on the metal shim is mostly release agent along |
| | with a light amount of fine wood dust*. |
| 3.5 | Metal shim self-released during the first 2 press cycles (no manual assistance required) |
| | but for the 3^{rd} and 4th press cycles very light manual assistance at a corner is needed to |
| | yield its release. Uptake on the metal shim is mostly release agent with some light |
| | amount of fine wood dust*. |
| 3.0 | Metal shim self-released during 1^{st} press cycles (no manual assistance required) but for |
| | the subsequent press cycles (2^{nd} through 4^{th}) shim is lightly stuck along one or two |
| | edges but no sticking detected in the interior (middle) region of the shim. Uptake on the |
| | metal shim is mostly release agent with a few visible wood particle specks^{†} (typically |
| | less than 5 particle specks). |
| 2.5 | Metal shim does not self-release and is lightly stuck along multiple (2-4) edges. |
| | Minimal to no sticking detected in the interior (middle) region of the shim. In terms of |
| | uptake, small wood particle specks^{†} are stuck near the edges and some in the interior |
| | (middle) region of the metal shim. The total number of wood particle specks is typically |
| | about 5-10. |
| 2.0 | Metal shim does not self-release. The shim is lightly stuck along all 4 edges plus some |
| | sticking is also detected in the interior (middle) region of the shim. In terms of uptake, |
| | small wood particle specks^{†} are visible across the entire surface of the metal shim |
| | whereby the total number of them is typically about 10-15. |
| 1.5 | The metal shim is moderately stuck across its entire surface but can still be manually |
| | removed with some additional force being applied with a scraper or putty knife. In |
| | terms of uptake, an increased level of wood particle specks^{†} is visible across the entire |
| | surface of the metal shim whereby the total number of them is typically about 15-20. |
| 1.0 | The metal shim is stuck across its entire surface but can still be manually removed with |
| | more assertive force being applied with a scraper or putty knife. In terms of uptake, a |
| | lot of wood particle specks are visible across the entire surface of the metal shim. The |
| | total number of wood particle specks^{†} is typically greater than 20. |
| 0.0 | The metal shim is fully stuck to the PB panel across its entire surface and requires that it |
| “No release; | be aggressively pried up with a flat head pry bar. Removal of the shim requires the pry |
| shim completely | bar head to be dug into the wood panel and the prying force will frequently cause the |
| stuck” | panel to break off into large wood fragments (about 5 mm in size or large) still stuck on |
| | the shim which must be further aggressively scrapped off. |

Note:
*The fine wood dust is typically about 0.5 mm in size or less and were visible on the metal shim under low magnification with a digital microscope set at 125x.
^{†}Wood specks that were readily visible on the metal shim with the naked eye and manually counted were typically about 1.25-2.5 mm in size.

### Testing of Film Build-Up On & Corrosive Metal Loss for Metal Shims

The film build-up tendencies and the metal corrosion inhibition properties of several commercial external release agents used for ligno-cellulose composites and for various experimental release agents were comparatively tested below using the following testing methodology:
The low-carbon steel metal shim material that was employed in this buildup versus corrosion testing was again generated from PRECISION BRAND shim stock sheet, Mfr #16870, which is a cold rolled flat sheet that is 0.01″ in thickness produced from 1008-1010 grade low carbon steel. However, four test shim coupons, 6″×6″×0.01″ in dimension, were created for use in each test series. The test shim coupons to be used in the testing are cleaned with IPA solvent to remove any protective oils then pre-weighed 20 before use to get a precise tare weight for the clean virgin shim. A typical 6″×6″×0.01″ test shim coupon weighs about 46.5±1.0 g. This flat shim stock material was determined to have an average Ra surface roughness value of about 30 micro-inches (or 0.76 microns) via its measurement with a Starrett SR160 model profilometer unit that employs a diamond stylus tip probe having a profile resolution of 0.01 microns. The Ra 25 value of 30 micro-inches was the average of five determinations done on an unused piece of cleaned test shim measured at five different locations. This low-carbon shim stock sheet was selected for our lab testing use because its Ra value more closely resembled the RMS roughness specification of 63 micro-inches for the 1020 hot rolled steel plate that is commonly used in commercial press platens that produce OSB wood panels. While the Precision 16870 shim material is still smoother it comes a lot closer in Ra surface roughness value than other low carbon steel shim stock materials that were checked (particularly those that are produced in roll form and produced at thickness levels of 0.01 inches or less). For example, average Ra values of about 0.30 microns (11.8 micro-inches) were determined for the 0.01″ 1008-1010 grade shim stock supplied by PRECISION in roll form (Mfr #16710). Surface roughness is known from the literature to play a role in metal corrosion rates and the objective was to conduct testing that was as close as possible to commercial end-use parameters.
Surface film pickup on the metal shims and/or corrosive weight loss associated with the metal test shims was quantified by the average weight change for the four metal test shim coupons after being subjected to a total of 40 press cycles. Weight changes after completion of the 40 press cycles were recorded before and after the resultant test shims were cleaned as cleaning them with an IPA (isopropanol) plus MEK (methyl ethyl ketone) solvent wash helps to remove any film build-up arising from the release agent. It was important to track both surface film pickup weights arising from the external release as well as metal loss arising from corrosion as the metal test coupons can show a gain in weight from film buildup but once the film deposit is washed off with solvent the remaining metal shim coupon can subsequently show a net negative loss in weight due to underlying corrosion of the metal. The overall buildup of film is also important to monitor because excessive buildup on the steel press platens (masking) can become problematic and result in press downtime for cleaning. Excessive film buildup issues on the platens can also affect heat transfer from the heated platen to the composite that is being pressed and cured.
In the testing conducted over 40 press cycles, pre-formed commercial OSB panels (LP Corp. grade; 7/16″ thickness; using pMDI adhesive) purchased from Home Depot were used as the wood source and these 4′×8′ OSB panels were subsequently cut up into 14″×14″× 7/16″ test boards for lab testing use. A new test board is used for each press cycle. Normally, OSB wood strands plus pMDI adhesive would be blended together and used in a press cycle based testing protocol but we have found through past experience that for quantifying film build-up of releases and for metal loss corrosion studies that the test results obtained from using pre-formed OSB panels are very similar to those where a mat of OSB strands is pressed. The primary advantage of using pre-formed OSB panels in a laboratory setting is that a lot more press experiments can be conducted since blending the OSB strands plus pMDI adhesive and subsequently hand forming the wood pile can be very time consuming when only a small pilot scale blender is available for use. This is particularly the case given the need to do 40 press cycles for a given experiment to see noticeable differences in metal corrosion loss. The close correlation of results between the above lab method and typical commercial OSB practice employing OSB strands and pMDI adhesive as the starting materials is subsequently presented and discussed in Example 8.
The external release agents to be tested were all reduced in actives weight content to 10.0% using the appropriate amount of 40 ppm hardness dilution water which were then spray applied onto the top of the pre-formed OSB test board using an aerosol assisted PREVAL Sprayer unit equipped with a trigger spray head. The OSB test board was spray coated with the 10 wt. % active release agent solution at a target active basis application level of 1.15 dg/sq. ft. This release application level is higher than what is commonly used in the industry to produce standard 7/16″ OSB panels but this application level was chosen deliberately as a stress test for monitoring corrosion and for monitoring film buildup tendencies. The four clean low-carbon steel shim coupons (6″×6″×0.01″), which have been surface primed with a layer of release that's baked on before initial use, are placed on top of the release treated OSB test board evenly spaced out within the board's middle surface quadrants. The release treated OSB test board with its four steel shim test coupons sit between a pair of 14-gauge mild steel A1011 plates, whereafter the entire assembly of bottom steel plate/release treated OSB test board/four test shim coupons/top steel plate is pressed using an 18″×18″ Wabash electrically heated press unit for 140 seconds heated at 415° F. using 17-24 tons of applied pressure with bump assist.
   Before use, the face of the bottom mild steel plate on which the OSB test board is placed was also primed with the 10 wt. % active release agent solution which is baked on at an active basis application level of about 0.4 dg/sq. ft. and this bottom steel plate was re-primed with release agent after every 10th press during the duration of the 40 cycle test series.
After each press cycle, the 10 wt. % active release agent was spray applied onto a new OSB test board at an active basis application level of 1.15 dg/sq. ft. and the above press method protocol is repeated. This testing procedure is replicated until a total of 40 press cycles has been completed.
Steel shim coupon weights are measured and recorded after every 10th press cycle using a 4-decimal place Ohaus analytical balance. Furthermore, upon completion of the 40 total press cycles, the final net shim weights are recorded and then averaged across the four steel test shim coupons. This average is the shim's net weight change before cleaning and provides information on how much film build-up is occurring relative to the original recorded tare weights. Some film buildup arising from the release chemistry can be helpful in terms of protecting the metal shim against corrosion but too much excessive film build-up can be problematic as previously discussed. The four steel test shims are then cleaned using a combination of IPA plus MEK solvents to remove any film build-up associated with the release agent chemistry. After air drying the final net weight of each test shim after cleaning is determined and then averaged. This net average value is the shim weight change after cleaning which reflects any underlying metal loss arising from corrosion.
Assessment rating criteria associated with film buildup on the metal test shims (average net weight before cleaning) versus the corrosion performance criteria based on the test shim's average net weight after cleaning (whereby any film buildup residue has been removed) are summarized in Table III below.

TABLE III
Performance Criteria for Film Build-Up vs. Corrosive
Metal Loss for Test Shims After 40 Press Cycles
Average Net Wt. Changes for Four Test Shims; Net Wt. Changes
Expressed as +/−mg Typical Weight of 6″ × 6″ × 0.01″
Low Carbon Steel Shims = about 46.5 ± 1.0 g

| | Shim Average Net Wt. | |
|---|---|---|
| Shim Average | Change after 40 Press | |
| Net Wt. Change | Cycles & Post-Cleaning, in mg | |
| Before Cleaning | (Negative Values Reflect | |
| off Film, in mg | Metal Loss from Corrosion) | |
| Acceptable Range Associated | Acceptable | Preferred |
| with Film Buildup after 40 | “Good” | “Excellent” |
| Cycles | Range | Range |
| 0.0 to +25.0 mg | −1.8 to +10.0 mg | 0.0 to +4.0 mg |

Physical Testing Methods Associated with Characterizing External Release Formulations
Viscosity: BF Viscosities for the waterborne external release formulations were all determined at 25° C. using a Brookfield RVDVE Viscometer unit equipped with standard disc spindles (#2 through #4 spindles were used appropriately depending on the specific viscosity range being tested) and readings were measured at 100 rpm.
Specific Gravity: All Specific Gravity measurements, unless otherwise noted, were determined at 25° C. with a Mettler Densito 30PX specific gravity gun which employs the oscillating U-shaped tube method. This measurement method is based on the principle that the oscillation frequency of a body is a function of its mass. Aqueous release solutions of high viscosity, BF Viscosity (@ 100 rpm)≥200 cPs, which are difficult to siphon with the Mettler specific gravity gun were instead measured at 25° C. using a stainless steel 100 cc Wt./gallon Specific Gravity Cup obtained from GARDCO in accordance with the method defined for liquid coatings in ASTM D1475.
Actives Content in Weight %: The total actives content of the waterborne, release formulations expressed in terms of Weight % is the total weight amount of all non-volatile substances therein which were analytically determined using a halogen, heating lamp Moisture Analyzer Balance, A&D Model MF-50, employing a pair of glass fiber pads in the aluminum pan and utilizing a temperature setting of either 150° C. or 100° C. in accordance with the testing protocol generally defined in Method B of ASTM D3926. Release compositions that were alkali metal salts of fatty acids or of phosphate esters were typically determined at 150° C. while the release compositions of the present invention that were produced by reacting acidic phosphate esters with basic ethoxylated fatty amines were determined at 100° C.
pH Determinations: The pH of aqueous release agent solutions was determined by two different types of pH probes depending on the following:
   a) The release agent employs a phosphate ester or a fatty acid in the formulation that was partially or fully neutralized with an alkali metal hydroxide base to form an alkali metal salt of the phosphate ester or an alkali metal soap of the fatty acid; the aqueous solutions for these formulations tend to be more alkaline and have a higher ionic strength.
      In this instance the solution pH values for all fatty acid soaps and phosphate ester soaps were determined at 25° C. using an Oakton pH 450 meter equipped with a double junction pH probe that is suited for high ionic strength conditions (Sensorex Model No. SG1041CD used in combination with an Oakton ATC probe 35618-05 for temperature compensation).
   b) The release employs a combination of nonionic surfactants or employs a combination of phosphate ester plus tertiary ethoxylated fatty amine surfactant; the aqueous solutions for these formulations are more neutral in pH and are lower in ionic strength.
      In this instance the solution pH values were determined at 25° C. using an Oakton pH 450 meter equipped with a standard single junction pH probe (Oakton Model No. 35805-05 in combination with an Oakton ATC probe 35618-05 for temperature compensation).

### ILLUSTRATIVE EXAMPLES

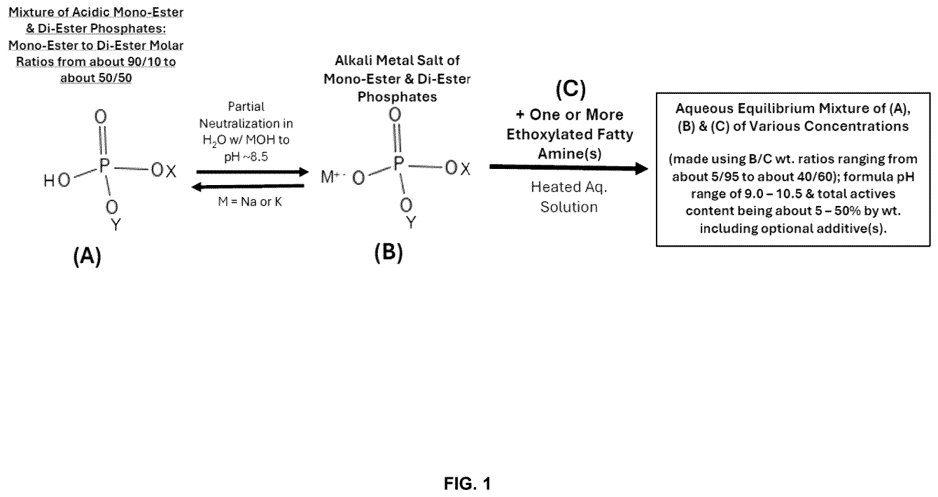

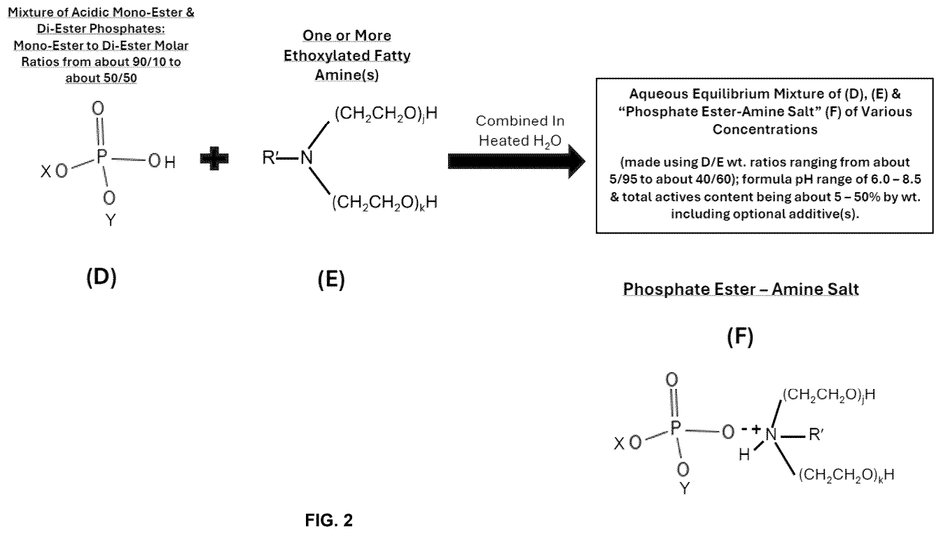

A number of tests were conducted to demonstrate the quality control properties of known release agents and those of the inventive formulation as well as other testing relating to different aspects of the invention formulation. More particularly, Example 1 tests known release agents for their quality control (QC) and release performance properties including weight pickup on shim, release rate, shim weight gain before cleaning and shim weight gain after cleaning. Example 2 tests potassium phosphate ester ethoxylate soaps alone for their QC and release performance properties. Example 3 tests tertiary ethoxylated fatty amines alone for their QC and release performance properties. Example 4 tests different combinations of the ethoxylated fatty amines and either alkyl phosphate esters or phosphate ester ethoxylates within the scope of the inventive formulation and made by the process of FIG. 1. Example 5 tests different combinations of the ethoxylated fatty amines and either alkyl phosphate esters or phosphate ester ethoxylates within the scope of the inventive formulation and made by the process of FIG. 2. Example 6 tests formulations from Table VIII and Example 5 with lower dosages of the formulation applied to the mats and platens as compared to Example 5 to show the effectiveness of the formulation at lower applied doses when making the engineered wood composite products. Example 7 tested the inventive formulations at higher levels of active content amount to determine the effectiveness of such higher active content formulations after their post-dilution to 10% actives content for application. Example 8 tests one of the preferred formulations from Table VIII for release quality performance when run on a pilot scale level OSB press for comparison to the lab scale testing conducted in Example 5.

### Example 1

In this comparative example a series of commercially available external release agents from various manufacturing sources were collected and subsequently characterized by their standard QC properties which are summarized in Table IV. The external release agents shown in Table IV span the compositional range from various potassium soaps of saturated and of unsaturated fatty acids, potassium salts of a phosphate ester ethoxylate blend and finally a blend of nonionic surfactants. They range in pH, as measured in their “as supplied” concentrate form, from 12.45 down to about 5.67. These external release agents were all reduced in actives weight content to 10.0% using the appropriate amount of 40 ppm hardness dilution water for subsequent spray application onto the top of the PB face wood pile for release testing or spray application onto the pre-formed OSB panel for shim corrosion versus film buildup testing in accordance with the test method protocols previously discussed. All the commercial release agents were found to be effective releases as assessed on a particle board composite purposely utilizing a very high 7% pMDI adhesive content as an extreme stress test for release. The release ratings for the various chemistries ranged from 2.5 to 3.0 on a scale of 0 to 4.0 with TechKote PR506HV being the most effective release agent which also largely mitigated any pickup of resin and wood. However, all the commercial release agents listed in Table IV had issues with either film buildup originating from the release or they showed significant losses in test shim weight indicating the onset of metal corrosion. For example, TechKote 506HV yielded the worst corrosion performance showing a net shim weight loss after cleaning of −70.4 mg. The other TechKote releases derived from potassium soaps of other fatty acids differing in carbon chain length distribution and degree of unsaturation also yielded metal corrosion levels of concern. Surprisingly, the nonionic surfactant release formulation (WC-8287W) also had a deleterious impact on corrosion properties which suggests that fatty acids and high solution pH's are not the only factors influencing corrosion. In contrast, the phosphate ester based release product, EPR8300-24, resulted in significant film buildup on the metal shim which could not be removed via cleaning with an organic solvent (IPA plus MEK). This film buildup no doubt helps to protect the steel surface from corroding, but this level of film buildup becomes problematic resulting in frequent shutdown of the presses for cleaning. Consequently, none of these external release agents currently in use in the industry meet the release performance requirements set forth in this invention.

TABLE IV
Release Performance, Film Buildup and Corrosion Properties
of Commercial Release Agents as Comparative Controls

| | Commercial | | | | |
|---|---|---|---|---|---|
| | Wood | | | | |
| | Release | | | BF Visc., | |
| | Chemistry | | Total Wt. % | 25° C., | |
| | by | Release | Actives | Sp# 2 @ | Specific |
| Expt. | Tradename & | Chemistry | Content* & | 100 rpm, | Gravity, |
| No. | Manufacturer | Description | pH at 25° C.^{†} | cPs^{††} | g/ml^{‡} |
| A | TechKote | Fully Neutralized | pH = 12.05 | 72 | 1.025 |
| | PR506HV | C₈-C₁₈ | @ 31.70% | | |
| | PSG/SASCO | Saturated Fatty | | | |
| | Chemical | Acid, K Salt plus | | | |
| | | adjunct additives | | | |
| | | for water | | | |
| | | hardness control | | | |
| | | & extra release | | | |
| B | TechKote | Fully Neutralized | pH = 12.45 | 80 | 1.005 |
| | PR487 | C₁₆-C₂₀ | @ 17.70% | | |
| | PSG/SASCO | Saturated & C₁₈- | | | |
| | Chemical | C₂₀ Unsaturated | | | |
| | | Fatty Acids, K | | | |
| | | Salt | | | |
| C | TechKote | Fully Neutralized | pH = 11.98 | 67 | 1.012 |
| | PR1127 | C₈-C₁₈ Saturated | @ 25.50% | | |
| | PSG/SASCO | & C₁₆-C₁₈ | | | |
| | Chemical | Unsaturated Fatty | | | |
| | | Acids, K Salt plus | | | |
| | | adjunct corrosion | | | |
| | | inhibitor additive | | | |
| D | EPR8300-24 | Blend of | pH = 8.87 | 42 | 1.0617 |
| | Polyventive | Ethoxylated | @ 24.35% | | |
| | | Phosphate Mono- | | | |
| | | alkyl & Di-alkyl | | | |
| | | Esters (alkyls = | | | |
| | | C₈ & C₁₃), KOH | | | |
| | | Neutralized to | | | |
| | | approx. pH 9 plus | | | |
| | | adjunct defoamer | | | |
| | | additive | | | |
| E | WC-8287W | Blend of | pH = 5.67 | 248 | 1.053 (Spg |
| | ChemTrend | Nonionic | @ 51.95% | | Cup) |
| | | Surfactants | | | |

| | Release Testing on PB | | Shim Corrosion Testing on | |
|---|---|---|---|---|
| | (4 press cycles; 7% pMDI; RA | | 7/16″ OSB Panel | |
| | Dosage = 0.5 dg/sq. ft.) | | (40 press cycles; RA Dosage = 1.15 dg/sq. ft.) | |
| | | Release | Shim Wt. | Shim Wt. Gain |
| Expt. | Wt. Pickup on | Rating: | Gain Before | or Loss After |
| No. | Shim, mg | 0 → 4 | Cleaning, +/−mg | Cleaning, +/−mg |
| A | +8.7 | 3.0 | −47.0 | −70.4 |
| B | +9.3 | 2.5 | −38.2 | −57.4 |
| C | +10.2 | 2.5 | −26.7 | −41.9 |
| D | +10.1 | 2.5 | +57.1 | +24.6 |
| E | +8.0 | 2.5 | −36.5 | −51.8 |

Note:
*The non-volatile actives content expressed in Wt. % of the various commercial releases were determined using a halogen, heating lamp Moisture Analyzer Balance, A&D Model MF-50, employing a pair of fiber pads in the aluminum pan and were run at a temperature setting of 150° C. in accordance with the testing protocol generally defined in Method B of ASTM D3926.
^{†}The solution pH values for all fatty acid soaps and phosphate ester soaps were determined at 25° C. using an Oakton pH 450 meter equipped with a double junction pH probe that is suited for high ionic strength conditions (Sensorex Model No. SG1041CD used in combination with an Oakton ATC probe 35618-05 for temperature compensation). The solution pH values for nonionic surfactant-based releases, like WC-8287W, were determined at 25° C. using an Oakton pH 450 meter equipped with a standard single junction pH probe (Oakton Model No. 35805-05 used in combination with the Oakton ATC probe 35618-05 for temperature compensation).
^{††}The Brookfield Viscosities were all determined at 25° C. using a Brookfield RVDVE Viscometer unit equipped with a #2 standard disc spindle and were measured at 100 rpm.
^{‡}All Specific Gravity measurements were determined at 25° C. with a Mettler Densito 30PX specific gravity gun which employs the oscillating U-shaped tube method unless otherwise noted.

### Example 2

In this comparative example, a series of partially neutralized phosphate ester ethoxylates as their potassium salts were produced by reacting the phosphate ester ethoxylate with potassium hydroxide in water at a target total actives content of 24-25% by weight. Based on the COA reported Acid Value of the starting phosphate ester, as determined by its titration to a pH of 9.5, a stoichiometric quantity of 46.19% active liquid KOH reagent was added to bring the finished batch pH as measured at 25° C. to about 8.2-8.3. The other physical properties for these potassium phosphate ester ethoxylate soaps, such as their total weight % actives, their initial Brookfield viscosity at 25° C. and 100 rpm and their specific gravity at 25° C. are summarized in Table V. These phosphate ester soap compositions were all subsequently reduced in actives weight content to 10.0% using the appropriate amount of 40 ppm hardness dilution water for subsequent spray application onto the top of the PB face wood pile for release testing or spray application onto the pre-formed OSB panel for shim corrosion versus film buildup testing in accordance with the test method protocols previously discussed. As seen in Table V, all the phosphate ester soap compositions yielded very good release performance in our high pMDI/PB stress test; their release ratings ranged from 3.5 to 4.0 on a scale of 0.0 to 4.0. However, only one of the compositions (Expt. No. F) which was derived from neutralizing a PEG-4 oleyl ether phosphate with KOH, was found to yield somewhat promising results with respect to film buildup and metal corrosion loss. The initial amount of weight gain on the test shims after 40 press cycles was still unacceptably high (significantly greater than +25.0 mg) but the level of buildup was notably lower than with any of the other phosphate ester soaps tested in this example. Furthermore, the film deposit obtained in Expt. No. F was able to be cleaned off reasonably well to yield a final net shim weight change of +7.6 mg which is within our “good” but not preferred “excellent” range. In summary, none of the phosphate ester soaps were found to meet the overall performance requirements set forth for external releases in this invention. However, the PEG-4 Oleyl Ether Phosphate showed enough promise that it became a chemistry of interest in our subsequent investigations as detailed below.

TABLE V
Batch Properties and Release Performance of Comparative Phosphate Ester K-Soaps

| | | | | |
|---|---|---|---|---|
| | | | Partially | Total Wt. % |
| | | | Neutralized | Actives |
| Expt. | Starting Phosphate | Alkali Metal | Phosphate | Content** & |
| No. | Ester & Tradename | Base Reactant | Ester, K Salt* | pH at 25° C.^{†} |

K-Soaps Derived from Phosphate Ester Ethoxylates

| | | | | |
|---|---|---|---|---|
| F | PEG-4 Oleyl | KOH | PEG-4 Oleyl | pH = 8.22 @ 24.95% |
| | Ether Phosphate | | Ether Phosphate, | |
| | | | Potassium Salt | |
| G | PEG-4 C₁₂-C₁₄ Alkyl | KOH | PEG-4 C₁₂-C₁₄ Alkyl | pH = 8.31 @ 24.60% |
| | Ether Phosphate | | Ether Phosphate, | |
| | | | Potassium Salt | |
| H | PEG-3 C₁₂-C₁₄ Alkyl | KOH | PEG-3 C₁₂-C₁₄ Alkyl | pH = 8.29 @ 24.95% |
| | Ether Phosphate | | Ether Phosphate, | |
| | | | Potassium Salt | |
| I | PEG-2 2-Ethylhexyl | KOH | PEG-2 2-Ethylhexyl | pH = 8.26 @ 23.90% |
| | Ether Phosphate | | Ether Phosphate, | |
| | | | Potassium Salt | |

| | | | Release Testing on PB | | Shim Corrosion Testing on | |
|---|---|---|---|---|---|---|
| | | | (4 press cycles; 7% pMDI; | | 7/16″ OSB (40 press cycles; | |
| | BF Visc., | | RA Dosage = 0.5 dg/sq. ft.) | | RA Dosage = 1.15 dg/sq. ft.) | |
| | 25° C., Sp# | Specific | Wt. | Release | Shim Wt. Gain | Shim Wt. Gain or |
| Expt. | 2 @ 100 | Gravity, | Pickup on | Rating: | Before | Loss After |
| No. | rpm, cPs^{††} | g/ml^{‡} | Shim, mg | 0 → 4 | Cleaning, +/− mg | Cleaning, +/− mg |

K-Soaps Derived from Phosphate Ester Ethoxylates

| | | | | | | |
|---|---|---|---|---|---|---|
| F | 140.2 | 1.0356 | +4.8 | 3.5 | +41.7 | +7.6 |
| G | 86.4 | 1.0445 | +4.3 | 3.5 | +59.3 | +13.0 |
| H | 54.4 | 1.0607 | +7.0 | 3.5 | +61.7 | +24.7 |
| I | 41.8 | 1.0490 | +4.0 | 4.0 | +65.9 | +24.4 |

Note:
*All reactions involving a phosphate ester and KOH reactant were conducted in DI water to yield a resultant solution pH of about 8.0-8.5 at 25° C. for batches having a total actives content of about 24-25% by weight.
**The non-volatile actives content in Wt. % were determined using a halogen-based heating lamp Moisture Analyzer Balance, A&D Model MF-50, employing a pair of fiber pads in the aluminum pan and using a temperature setting of 150° C. in accordance with the testing protocol generally defined in Method B of ASTM D3926.
^{†}The solution pH values were determined at 25° C. using an Oakton pH 450 meter equipped with a double junction pH probe that is suited for high ionic strength conditions (Sensorex Model No. SG1041CD used in combination with an Oakton ATC probe 35618-05 for temperature compensation).
^{††}The Brookfield Viscosities were all determined at 25° C. using a Brookfield RVDVE Viscometer unit equipped with a #2 standard disc spindle and were measured at 100 rpm.
^{‡}All Specific Gravity measurements were determined at 25° C. with a Mettler Densito 30PX specific gravity gun.

### Example 3

In this comparative example, a series of tertiary ethoxylated fatty amines were first dispersed into deionized water at a total actives content of 10.0% by weight. The physical properties of each ethoxylated fatty amine solution were then determined; their initial Brookfield viscosity at 25° C. measured at 100 rpm and their pH and specific gravity values at 25° C. are summarized in Table VI. Tertiary ethoxylated fatty amines were of general interest for two reasons:
a) The prior art (e.g., U.S. Pat. No. 9,303,113 of Grigsby, et. al.) has indicated that ethoxylated fatty amines can act as an anti-making agent to reduce build-up on the low carbon steel platens when they are used in ligno-cellulose composites employing isocyanate-based adhesives. The ability to mitigate build-up residues on the platens was therefore a performance property of interest.
b) The amine functionality of the ethoxylated fatty amines was of chemical interest because of their potential to function as bases and thereby help neutralize any acidic wood extractives that might be carried to the surface of the wood composite by steam that's internally created during the press step. Neutralizing these acidic wood extractives might therefore help to mitigate any corrosive effects associated with them coming into surface contact with the hot metal platens.
c) Tertiary fatty amines can form amine salts with acidic inorganic or acidic organic compounds and these tertiary ammonium salts can frequently behave as good corrosion inhibitors at the surface of the metal. This leaves open the possibility that various release chemistries having acidic groups might be combined with the tertiary ethoxylated fatty amines to yield amine salt species that have dual functionality (i.e., release and corrosion inhibition).

As seen in Table VI, all the ethoxylated fatty amine solutions of 10% concentration when applied as an external release agent yielded a low degree of shim metal loss. The net shim weight changes after 40 press cycles and subsequent cleaning ranged from +1.3 mg to −3.5 mg. Several of the 10% ethoxylated fatty amine solutions (namely Expt. K, M and Q) showed an almost negligible change in shim weight suggesting essentially no metal loss from corrosion. These corrosion results were promising; however, the disappointing performance aspect associated with the ethoxylated fatty amines was their release properties when they were used as the sole release agent in the ligno-cellulose composite making process. This finding is somewhat contrary to the data presented in the U.S. Pat. No. 9,303,113 prior art but one needs to keep in mind that the OSB testing being done there was also employing a paraffin wax internal release additive which undoubtedly aided overall release performance.

Most of the release rating values for the ethoxylated fatty amines presented in Table VI were determined after only 2 press cycles (rather than after the standard 4 press cycles) unless otherwise noted. This is because overall release performance was not very good for most of the ethoxylated fatty amines. You will note their release characteristics got progressively worse as more press cycles were completed. Amongst the various ethoxylated fatty amines, the PEG-5 Cocamine (per Expt. K) yielded the best overall release performance both in terms of release rating (3.0) and for lowest wood/resin pickup on the test shim (+6.0 mg) while also mitigating any shim metal corrosion loss. This result differs from the preferred ethoxylated fatty amine used in the U.S. Pat. No. 9,303,113 patent art whereby a PEG-20 tallow amine was the anti-masking agent of choice.

Since the PEG-5 Cocamine offered the best overall performance characteristics in this study we subsequently decided to examine combinations of PEG-4 Oleyl Ether Phosphate and PEG-5 Cocamine to see what they would collectively provide. See data presented and discussed in Examples 4 and 5 below.

TABLE VI
Batch Properties and Release Performance of Tertiary Ethoxylated Fatty Amines

| | Ethoxylated Fatty | | | |
|---|---|---|---|---|
| | Amine Composition in | BF Viscosity, | | Specific |
| Expt. | DI Water, 10% by Wt. | 25° C., Sp# 2 | pH @ | Gravity*, |
| No. | active Concentration | @ 100 rpm, cPs^{†} | 25° C.** | g/ml |
| J | 8% PEG-2 Cocamine + | 499 (Sp #3) | 9.48 | 0.9766 |
| | 2% PEG-5 Cocamine | | | (Spg Cup) |
| K | 10% PEG-5 Cocamine | 18.0 | 10.04 | 0.9987 |
| L | 10% PEG-10 Cocamine | 16.4 | 10.10 | 1.0057 |
| M | 10% PEG-15 Cocamine | 16.8 | 9.96 | 1.0082 |
| N | 10% PEG-5 Oleylamine | 202.8 | 9.86 | 0.9957 |
| | | | | (Spg Cup) |
| O | 10% PEG-10 Oleylamine | 16.4 | 9.57 | 0.9975 |
| P | 10% PEG-10 Tallowamine | 16.0 | 9.85 | 1.0026 |
| Q | 10% PEG-20 Tallowamine | 17.2 | 9.83 | 1.0080 |

| | Release Testing on PB | | Shim Corrosion Testing on | |
|---|---|---|---|---|
| | (2 press cycles^{‡}; 7% pMDI; | | 7/16″ OSB (40 press cycles; | |
| | RA Dosage = 0.5 dg/sq. ft.) | | RA Dosage = 1.15 dg/sq. ft.) | |
| | | Release | Shim Wt. Gain | Shim Wt. Gain |
| Expt. | Wt. Pickup | Rating: | Before | or Loss After |
| No. | on Shim, mg | 0 → 4 | Cleaning, +/−mg | Cleaning, +/−mg |
| J | +12.5 (2 | 3.0 (2 | +5.9 | −2.9 |
| | cycles) | cycles) | | |
| K | +6.0 (2 | 3.0 (2 | +11.7 | −0.3 |
| | cycles) | cycles) | | |
| | and | and | | |
| | +18.1 (4 | 1.5 (4 | | |
| | cycles) | cycles) | | |
| L | +10.7 (2 | 2.0 (2 | +12.9 | −2.1 |
| | cycles) | cycles) | | |
| M | +7.8 (2 | 2.0 (2 | +16.7 | +0.3 |
| | cycles) | cycles) | | |
| N | +8.6 (2 | 2.0 (2 | +15.9 | −3.5 |
| | cycles) | cycles) | | |
| O | +10.3 (2 | 2.0 (2 | +18.4 | −1.2 |
| | cycles) | cycles) | | |
| | and | and | | |
| | +21.7 (3 | 1.0 (3 | | |
| | cycles) | cycles) | | |
| P | +7.3 (2 | 2.0 (2 | +17.9 | +1.3 |
| | cycles) | cycles) | | |
| Q | +12.5 (2 | 1.5 (2 | +17.5 | −0.6 |
| | cycles) | cycles) | | |

Note:
*All Specific Gravity measurements, unless otherwise noted, were determined at 25° C. with a Mettler Densito 30PX specific gravity gun unless otherwise noted. Test solutions of high viscosity (BF Visc. ≥200 cPs) were instead measured at 25° C. using a stainless 100 cc Wt./gallon Specific Gravity Cup obtained from GARDCO in accordance with the method defined for liquid coatings in ASTM D1475.
**The solution pH values were determined at 25° C. using an Oakton pH 450 meter equipped with a standard single junction pH probe (Oakton Model No. 35805-05 in combination with an Oakton ATC probe 35618-05 for temperature compensation).
^{†}The Brookfield Viscosities were all determined at 25° C. using a Brookfield RVDVE Viscometer unit equipped with standard disc spindles (#2 or #3 spindle was used depending on the magnitude of the viscosity) and were measured at 100 rpm.
^{‡}Most release rating values were determined after only 2 press cycles (rather than after the standard 4 press cycles) unless otherwise noted. This is because overall release performance was not very good and the release rating got progressively worse as more press cycles were completed.

### Example 4

In this example, a series of external release compositions were prepared in accordance with the formulation making process of FIG. 1 whereby an acidic phosphate ester compound, such as an alkyl phosphate ester or a phosphate ester ethoxylate having both mono-ester and di-ester species, is first neutralized with an alkali metal hydroxide base (such as NaOH or KOH) to yield a partially neutralized, alkali metal salt of the phosphate esters having a solution pH of about 8.5 whereafter a tertiary ethoxylated fatty amine is then added to yield a composition having a defined active basis weight ratio of phosphate ester, potassium salt to ethoxylated fatty amine that ranges from about 5/95 to about 40/60. For the experimental formulations presented in Table VII, the test batches were produced to have a total actives content in wt. % ranging from about 25.1% to about 30.4%. All the release formulations of Table VII also contain a defoamer additive, Munzing DEE FO PG-20, at a concentration level of about 0.1% by wt. to help mitigate process foam. As exemplary of the experimental release formulations listed in Table VII, the preparative lab details for Expt. R, which employs a PEG-4 Oleyl Ether Phosphate (that has a mono-ester to di-ester molar ratio of about 50/50) in combination with a PEG-5 Cocamine are as follows:
1) Starting materials that were preheated to 40° C., included:
   a. PEG-5 cocamine (Ethox CAM-5);
   b. PEG-4 oleyl ether phosphate having a 50/50 molar ratio of mono-ester to di-ester (Ethfac 140); with Acid Value=144.51 as determined at pH 9.5;
   c. deionized batch water.
2) The two step formulating process of FIG. 1 was carried out in a 1-liter reaction flask equipped with a 1.5-inch diameter dispersion blade.
3) 573.01 g of DI water preheated to 40° C. is added to the flask;
4) 15.66 g of liquid KOH reagent (46.19% active) is added and mixed in well;
5) 51.33 g of Ethfac 140 preheated to 40° C. was then dosed in slowly over about 6 minutes and the batch was allowed to subsequently mix for an additional 20 min. to partially neutralize the acidic phosphate ester and form a potassium salt of PEG-4 oleyl ether phosphate. Neutralization of the Ethfac 140 with the KOH amount that was added in step 4 results in the formation of 56.22 active basis grams of phosphate ester, potassium salt.
6) 160.00 g of Ethox CAM-5 preheated at 40° C. was then dosed in slowly at a rate of about 8.0 g per minute; once the ethoxylated fatty amine addition was completed the batch is maintained at 40-45° C. for an additional 20 min. of mixing to yield a homogeneous solution; and
7) Lastly 0.80 g of DEE FO PG-20 defoamer was added and mixed in well to deair which brings the finished total batch weight to 800.8 g. Proper dispersion of the defoamer yields a translucent solution.
8) Batch details for Expt. R formulation as reported in Table VII are thus:
   a. liquid KOH/phos ester wt. ratio=15.66/51.33=0.3051;
   b. K-salt of phosphate ester/ethoxylate fatty amine wt. ratio=56.22/160.00=26/74;
   c. total actives content in Wt. %=(56.22+160.00+0.8)/800.8×100=27.1%.

Referring to FIG. 1, the phosphate esters (A), and the alkali metal salts thereof (B), that are useful include the following:
One or more alkyl phosphate ester(s) derived from Fatty Alcohol feedstocks whereby:
   X=C₆-C₁₄ aliphatic carbon chain (linear or branched);
   Y=H or C₆-C₁₄ aliphatic carbon chain (linear or branched).
or
   One or more phosphate ester ethoxylate(s) derived from ethoxylated fatty alcohol Feedstocks whereby:
      X=—(CH₂CH₂O)_{z}—R where R=a C₆-C₂₀ aliphatic carbon chain (linear or branched, saturated or unsaturated) & z=2-10 units of EO;
      Y=H or —(CH₂CH₂O)_{z}—R where R=a C₆-C₂₀ aliphatic carbon chain (linear or branched, saturated or unsaturated) & z=2-10 units of EO.
or combinations of both phosphate ester types. Still referring to FIG. 1, the ethoxylated fatty amine(s) (C) that are useful are those shown in the formula (I) above, wherein R′=C₈-C₂₀ aliphatic group (linear or branched, saturated or unsaturated); and j+k=2-20 units of EO.

For FIG. 2, Component (D) is the same as component (A) in FIG. 1, and Component (E) is the same as component (C) of FIG. 1.

Other experimental release batches using several different phosphate ester ethoxylates and a C₈-C₁₀ alkyl phosphate ester were also produced in an analogous fashion using the associated reagent weight ratio targets and by targeting the total wt. % actives content as specified in Table VII. Their QC properties, release characteristics and corrosion versus buildup properties are summarized in Table VII. These experimental releases were all reduced in actives weight content to 10.0% using the appropriate amount of 40 ppm hardness dilution water for subsequent spray application onto the top of the PB face wood pile for release testing or for spray application onto the pre-formed OSB panel for shim corrosion versus film buildup testing in accordance with the test method protocols previously discussed. A review of the test data indicates that a few select phosphate ester, K-salt/PEG-5 cocamine combinations yielded formulations providing very favorable performance properties across all three key criteria (release, minimal film build-up and low metal corrosion loss). Particularly effective external releases were the Expt. R and the Expt. W formulations which both yielded very good release (with release ratings of 3.5 on a scale of 0 to 4.0) and both yielded minimal film buildup and were effective in mitigating metal corrosion loss (net weight gains after 40 press cycles and post cleaning were only +2.8 mg and +3.1 mg, respectively). The Expt. R formulation was based on using a PEG-4 oleyl ether phosphate having a 50/50 mole ratio of mono-ester to di-ester species whereas the Expt. W formulation was based on using a PEG-2 2-ethylhexyl ether phosphate. When employing either of these phosphate ester ethoxylates it was also interesting to note that the active basis weight ratio of phosphate ester, potassium salt to PEG-5 cocamine that was utilized in making the formulation had an impact on their performance properties (e.g., compare the performance of Expt. R to Expt. S and the performance of Expt. V to Expt. W. In the case of comparing the release formulations of Expt. V to Expt. W a change in phosphate ester, potassium salt to PEG-5 cocamine active basis weight ratio from 26/74 to 30/70 had a pronounced impact on their release performance characteristics; the release rating being improved from 2.5 to 3.5, respectively. The Expt. AA formulation, which employed a potassium salt of PEG-4 C₁₂-C₁₄ alkyl ether phosphate in combination with the PEG-5 cocamine at an active basis weight ratio of 20/80, was found to yield minimal film build-up while also mitigating metal corrosion loss but it was not one of the most preferred formulations in this study because it yielded lower than desired release characteristics (release rating was 2.5 on a scale of 0 to 4.0). In general, we prefer to see a minimum release rating of 3.0 to ensure there are no sticking issues in the press. Finally, it is also interesting to note the change in performance when utilizing a PEG-4 oleyl ether phosphate having a mono-ester to di-ester molar ratio of 50/50 versus using the analogous phosphate ester chemistry having a mono-ester to di-ester molar ratio of about 80/20 (e.g., compare the formulas of Expt. R and S to the corresponding formulas of Expt. T and U). The latter two release formulations that had a higher phosphate mono-ester content both tended to yield a lot more film build-up which is undesirable from a platen cleaning maintenance perspective. The data of Table VII illustrate that it is not easy to predict which combinations of phosphates ester, potassium salt and PEG-5 cocamine will work well with one another and to further know what active basis weight ratio of these components is needed to simultaneously yield the optimum release agent properties across all three performance criteria; these synergies had to be discovered through rigorous experimentation.

TABLE VII
Batch & Wood Release Properties of K-Salt, Phosphate Ester + Ethoxylated
Fatty Amine Compositions Produced by the Formulating Process of FIG. 1

| | | | | | |
|---|---|---|---|---|---|
| | Alkyl | | | Phos Ester, | |
| | Phosphate | | | K-salt/EFA | |
| | Ester (APE) or | Liquid | Ethoxylated | Wt. Ratio | |
| | Phosphate | KOH | Fatty | (& Total | BF Visc., |
| | Ester | (46.19%)/ | Amine | Actives | 25° C., Sp# |
| Expt. | Ethoxylate | Phos Ester | (EFA) | Target, in | 2 @ 100 |
| No. | (PEE)^{Φ} | Wt. Ratio* | Ingredient | Wt. %)^{‡} | rpm, cPs^{†} |

Reactions Employing Phosphate Ester Ethoxylates (PEE)

| | | | | | |
|---|---|---|---|---|---|
| R | PEG-4 Oleyl | 0.3051 | PEG-5 | 26/74 | 189.2 |
| | Ether Phosphate | | Cocamine | @ 27.1% | |
| | (50/50 mono/di) | | | | |
| S | PEG-4 Oleyl | 0.3105 | PEG-5 | 30/70 | 156.4 |
| | Ether Phosphate | | Cocamine | @ 25.1% | |
| | (50/50 mono/di) | | | | |
| T | PEG-4 Oleyl | 0.3667 | PEG-5 | 26/74 | 148.8 |
| | Ether Phosphate | | Cocamine | @ 27.1% | |
| | (80/20 mono/di) | | | | |
| U | PEG-4 Oleyl | 0.3667 | PEG-5 | 30/70 | 118.0 |
| | Ether Phosphate | | Cocamine | @ 25.1% | |
| | (80/20 mono/di) | | | | |
| V | PEG-2 2- | 0.4065 | PEG-5 | 26/74 | 50.4 |
| | Ethylhexyl | | Cocamine | @ 27.1% | |
| | Ether Phosphate | | | | |
| W | PEG-2 2- | 0.4065 | PEG-5 | 30/70 | 68.0 |
| | Ethylhexyl | | Cocamine | @ 30.4% | |
| | Ether Phosphate | | | | |
| X | PEG-3 C₁₂-C₁₅ | 0.3490 | PEG-5 | 26/74 | 158.0 |
| | Alkyl Ether | | Cocamine | @ 27.1% | |
| | Phosphate | | | | |
| Y | PEG-2 C₁₂-C₁₄ | 0.4695 | PEG-5 | 26/74 | 116.8 |
| | Alkyl Ether | | Cocamine | @ 27.1% | |
| | Phosphate | | | | |
| Z | PEG-3 C₁₂-C₁₄ | 0.4511 | PEG-5 | 26/74 | 138.6 |
| | Alkyl Ether | | Cocamine | @ 27.1% | |
| | Phosphate | | | | |
| AA | PEG-4 C₁₂-C₁₄ | 0.3592 | PEG-5 | 20/80 | 67.2 |
| | Alkyl Ether | | Cocamine | @ 25.1% | |
| | Phosphate | | | | |
| BB | PEG-4 C₁₂-C₁₄ | 0.3592 | PEG-5 | 22/78 | 73.0 |
| | Alkyl Ether | | Cocamine | @ 25.5% | |
| | Phosphate | | | | |
| CC | PEG-3 C₁₃ | 0.3276 | PEG-5 | 20/80 | 82.0 |
| | Alkyl Ether | | Cocamine | @ 25.1% | |
| | Phosphate | | | | |
| DD | PEG-3 C₁₃ | 0.3276 | PEG-5 | 26/74 | 138.0 |
| | Alkyl Ether | | Cocamine | @ 27.1% | |
| | Phosphate | | | | |

Reactions Employing Alkyl Phosphate Esters (APE)

| | | | | | |
|---|---|---|---|---|---|
| EE-1 | C₈-C₁₀ Alkyl | 0.5362 | PEG-5 | 20/80 | 54.8 |
| | Phosphate | | Cocamine | @ 25.1% | |
| | (50/50 mono/di) | | | | |
| EE-2 | C₈-C₁₀ Alkyl | 0.6467 | PEG-5 | 20/80 | 44.2 |
| | Phosphate | | Cocamine | @ 25.1% | |
| | (80/20 mono/di) | | | | |
| FF | C₈-C₁₀ Alkyl | 0.5444 | PEG-5 | 26/74 | 68.6 |
| | Phosphate | | Cocamine | @ 27.1% | |
| | (50/50 mono/di) | | | | |

| | | Release Testing on PB | | Shim Corrosion Testing on | |
|---|---|---|---|---|---|
| | | (4 press cycles; 7% | | 7/16″ OSB | |
| | | pMDI; RA Dosage = | | (40 press cycles; RA Dosage = | |
| | Finished | 0.5 dg/sq. ft.) | | 1.15 dg/sq. ft.) | |
| | Batch | Wt. | Release | Shim Wt. | Shim Wt. Gain |
| Expt. | pH @ | Pickup on | Rating: | Gain Before | or Loss After |
| No. | 25° C.** | Shim, mg | 0 → 4 | Cleaning, +/−mg | Cleaning, +/−mg |

Reactions Employing Phosphate Ester Ethoxylates (PEE)

| | | | | | |
|---|---|---|---|---|---|
| R | 9.70 | +4.7 | 3.5 | +15.1 | +2.8 |
| S | 9.68 | +4.4 | 3.5 | +13.0 | −0.8 |
| T | 9.60 | +8.0 | 3.0 | +23.7 | +8.2 |
| U | 9.52 | +5.5 | 3.5 | +25.6 | +6.8 |
| V | 9.74 | +5.4 | 2.5 | +12.4 | +1.7 |
| W | 9.75 | +3.8 | 3.5 | +13.6 | +3.1 |
| X | 9.78 | +6.8 | 3.5 | +16.1 | +5.5 |
| Y | 9.64 | +3.8 | 4.0 | +25.2 | +15.2 |
| Z | 9.71 | +2.8 | 3.0 | +25.3 | +12.1 |
| AA | 9.87 | +4.1 | 2.5 | +12.2 | +1.9 |
| BB | 9.61 | +4.7 | 3.5 | +8.5 | −2.4 |
| CC | 9.82 | +7.0 | 2.5 | +9.3 | −0.6 |
| DD | 9.76 | +4.2 | 4.0 | +9.4 | −1.6 |

Reactions Employing Alkyl Phosphate Esters (APE)

| | | | | | |
|---|---|---|---|---|---|
| EE-1 | 9.57 | +5.2 | 3.0 | +19.7 | +7.3 |
| EE-2 | 9.94 | +6.0 | 2.5 | +24.8 | +11.5 |
| FF | 9.55 | +2.3 | 3.5 | +27.3 | +13.3 |

Note:
*The wt. % concentration of the liquid potassium hydroxide used in all batch making experiments was determined from its specific gravity value to be 46.19%.
**The solution pH values were determined at 25° C. using an Oakton pH 450 meter equipped with a double junction pH probe that is suited for high ionic strength conditions (Sensorex Model No. SG1041CD used in combination with an Oakton ATC probe 35618-05 for temperature compensation).
^{†}The viscosities were determined at 25° C. using a Brookfield RVDVE Viscometer unit equipped with standard disc spindles (#2 was used unless otherwise noted) and were measured at 100 rpm.
^{‡}The total actives content in weight % for all releases includes 0.1% by wt. of DEEFO PG-20 defoamer having been added to the batches.
^{Φ}The terms 50/50 mono/di and 80/20 mono/di shown in parenthesis refer to the mono-ester to di-ester molar ratios associated with the given phosphate ester chemistry.

### Example 5

In this example, a series of external release compositions were prepared in accordance with the formulation making process of FIG. 2 whereby an acidic phosphate ester compound, such as an alkyl phosphate ester and/or a phosphate ester ethoxylate having both mono-ester and di-ester species, is reacted directly with a tertiary ethoxylated fatty amine in an aqueous solution phase without the use of any other bases (hence no alkali metal hydroxides were employed). The active basis weight ratio of acidic phosphate ester to tertiary ethoxylated fatty amine can range from about 5/95 to about 40/60 whereby the resultant neutralization reaction in water yields a final formulation pH of about 6.0 to 8.5. As depicted in FIG. 2, the neutralization reaction yields an aqueous equilibrium mixture of acidic phosphate ester species, ethoxylated fatty amine and phosphate ester-amine ionic complex species whose relative concentrations will depend on the total actives content level, the phosphate ester to ethoxylated fatty amine weight ratio originally employed and the batch temperature. It is postulated here that the relative proportions of free ethoxylated fatty amine and phosphate ester-amine ionic complex which are present might be important from a performance standpoint. As an organic base the free ethoxylated fatty amine content likely helps to neutralize any acidic wood extractives that get liberated and make their way to the surface of the ligno-cellulose composite while the phosphate ester-amine salt species likely behave as a corrosion inhibitor chemistry on the surface of the metal platen. Acting together, they help to mitigate overall metal corrosion loss.

For the experimental formulations presented in Table VIII, the test batches were produced to have a total actives content in wt. % ranging from about 25.1% to about 35.1%. All the release formulations of Table VIII also contain a defoamer additive, Munzing DEE FO PG-20, at a concentration level of about 0.1% by wt. to help mitigate process foam. As exemplary of the experimental release formulations listed in Table VIII, the preparative lab details for Expt. HH, which employs a PEG-4 oleyl ether phosphate having a mono-ester to di-ester molar ratio of 50/50 in combination with a PEG-5 cocamine are as follows:
1) Starting materials that were preheated to 40° C., included:
   a. PEG-5 cocamine (Ethox CAM-5);
   b. PEG-4 oleyl ether phosphate having 50/50 molar ratio of mono-ester to di-ester (Ethfac 140); with Acid Value=144.51 as determined at pH 9.5; and
   c. deionized batch water.
2) The direct reaction formulating process of FIG. 2 was carried out in a 1-liter reaction flask equipped with a 1.5-inch diameter dispersion blade.
3) 600.00 g of DI water preheated to 40° C. is added to the flask;
4) 162.00 g of Ethox CAM-5 preheated at 40° C. was then dosed in slowly at a rate of about 8.0 g per minute; once the ethoxylated fatty amine addition was completed the batch is maintained at 40-45° C. for an additional 10 min. of mixing to ensure a homogeneous solution is produced;
5) 63.00 g of Ethfac 140 preheated to 40° C. was then dosed in slowly over about 10 minutes and the batch was allowed to subsequently mix for an additional 20 min. to fully disperse it and allow its in situ neutralization with the ethoxylated fatty amine (Ethox CAM-5);
6) Lastly 1.00 g of DEE FO PG-20 defoamer was added and mixed in well to deair which brings the finished total batch weight to 826.00 g. Proper dispersion of the defoamer yields a translucent solution.
7) Batch details for the Expt. HH formulation as reported in Table VIII are thus:
   a. phosphate ester/ethoxylated fatty amine wt. ratio=63/162=28/72; and
   b. total actives content in Wt. %=(63.00+162.00+1.00)/826×100=27.4%

Other experimental release batches using different phosphate ester ethoxylates, different alkyl phosphate esters or combinations of these two phosphate ester types were then produced in an analogous fashion using the associated reagent weight ratio targets and by targeting the total wt. % actives content as specified in Table VIII. Other ethoxylated fatty amines beyond PEG-5 cocamine were also explored in this study to determine whether any might offer some unexpected surprises when combined with a particular phosphate ester. The QC properties, release characteristics and corrosion versus buildup properties of all the formulations are summarized in Table VIII. These experimental release agents were all reduced in actives weight content to 10.0% using the appropriate amount of 40 ppm hardness dilution water for subsequent spray application onto the top of the PB face wood pile for release testing or for spray application onto the pre-formed OSB panel for shim corrosion versus film buildup testing in accordance with the test method protocols previously discussed.

TABLE VIII
Batch & Release Properties of Phosphate Ester - Amine
Releases from Direct Reaction Process of FIG. 2

| | | | | |
|---|---|---|---|---|
| | Phosphate | | APE/EFA or | |
| | Ester Ethoxylate | | PEE/EFA Wt. | Optional |
| | (PEE) or Alkyl | Ethoxylated | Ratio (& Total | Defoamer |
| Expt. | Phosphate Ester | Fatty Amine | Actives Target, | (Type & |
| No. | (APE)^{‡} | (EFA) | in Wt. %) | Wt. % Level) |

Reactions Employing Phosphate Ester Ethoxylates (PEE)

| | | | | |
|---|---|---|---|---|
| GG | PEG-4 Oleyl | PEG-5 Cocamine | 26/74 @ 25.1% | PG-20 @ 0.1% |
| | Ether Phosphate | | | |
| | (50/50 mono/di) | | | |
| HH | PEG-4 Oleyl | PEG-5 Cocamine | 28/72 @ 27.4% | PG-20 @ 0.1% |
| | Ether Phosphate | | | |
| | (50/50 mono/di) | | | |
| II | PEG-4 Oleyl | PEG-5 Cocamine | 30/70 @ 32.6% | PG-20 @ 0.1% |
| | Ether Phosphate | | | |
| | (50/50 mono/di) | | | |
| JJ | PEG-4 Oleyl | PEG-5 Cocamine | 26/74 @ 25.1% | PG-20 @ 0.1% |
| | Ether Phosphate | | | |
| | (80/20 mono/di) | | | |
| KK | PEG-4 Oleyl | PEG-5 Cocamine | 30/70 @ 35.1% | PG-20 @ 0.1% |
| | Ether Phosphate | | | |
| | (80/20 mono/di) | | | |
| LL | PEG-2 2-Ethylhexyl | PEG-5 Cocamine | 26/74 @ 25.1% | PG-20 @ 0.1% |
| | Ether Phosphate | | | |
| MM | PEG-2 2-Ethylhexyl | PEG-5 Cocamine | 30/70 @ 25.1% | PG-20 @ 0.1% |
| | Ether Phosphate | | | |
| NN | PEG-3 C₁₂-C₁₅ Alkyl | PEG-5 Cocamine | 30/70 @ 30.1% | PG-20 @ 0.1% |
| | Ether Phosphate | | | |
| OO | PEG-2 C₁₂-C₁₄ Alkyl | PEG-5 Cocamine | 26/74 @ 25.1% | PG-20 @ 0.1% |
| | Ether Phosphate | | | |
| PP | PEG-2 C₁₂-C₁₄ Alkyl | PEG-5 Cocamine | 26/74 @ 25.1% | PG-20 @ 0.1% |
| | Ether Phosphate | | | |
| QQ | PEG-2 C₁₂-C₁₄ Alkyl | PEG-5 Cocamine | 26/74 @ 25.1% | PG-20 @ 0.1% |
| | Ether Phosphate | | | |
| RR | PEG-2 C₁₂-C₁₄ Alkyl | PEG-5 Cocamine | 30/70 @ 25.1% | PG-20 @ 0.1% |
| | Ether Phosphate | | | |
| SS | PEG-3 iso-C₁₃ Alkyl | PEG-5 Cocamine | 26/74 @ 25.1% | PG-20 @ 0.1% |
| | Ether Phosphate | | | |
| TT | PEG-4 Oleyl | 75/25 w/w of PEG-5 | 20/80 @ 25.1% | PG-20 @ 0.1% |
| | Ether Phosphate | Cocamine to | | |
| | (50/50 mono/di) | PEG-2 Cocamine | | |
| UU | PEG-4 Oleyl | PEG-10 Cocamine | 30/70 @ 25.1% | PG-20 @ 0.1% |
| | Ether Phosphate | | | |
| | (50/50 mono/di) | | | |
| VV | PEG-4 Oleyl | PEG-15 Cocamine | 30/70 @ 25.1% | PG-20 @ 0.1% |
| | Ether Phosphate | | | |
| | (50/50 mono/di) | | | |
| WW | PEG-4 Oleyl | PEG-15 Cocamine | 35/65 @ 25.1% | PG-20 @ 0.1% |
| | Ether Phosphate | | | |
| | (50/50 mono/di) | | | |
| XX | PEG-4 Oleyl | PEG-10 | 30/70 @ 25.1% | PG-20 @ 0.1% |
| | Ether Phosphate | Tallowamine | | |
| | (50/50 mono/di) | | | |
| YY | PEG-4 Oleyl | PEG-10 | 35/65 @ 25.1% | PG-20 @ 0.1% |
| | Ether Phosphate | Tallowamine | | |
| | (50/50 mono/di) | | | |

Reactions Employing Alkyl Phosphate Esters (APE)

| | | | | |
|---|---|---|---|---|
| ZZ | C₈-C₁₀ Alkyl | PEG-5 Cocamine | 26/74 @ 25.1% | PG-20 @ 0.1% |
| | Phosphate | | | |
| AAA | C₈-C₁₀ Alkyl | PEG-5 Cocamine | 30/70 @ 25.1% | PG-20 @ 0.1% |
| | Phosphate | | | |
| BBB | 2-Ethylhexyl | PEG-5 Cocamine | 26/74 @ 25.1% | PG-20 @ 0.1% |
| | Phosphate | | | |
| CCC | C₁₂-C₁₄ Alkyl | PEG-5 Cocamine | 26/74 @ 25.1% | PG-20 @ 0.1% |
| | Phosphate | | | |
| DDD | Hexyl | PEG-5 Cocamine | 26/74 @ 25.1% | PG-20 @ 0.1% |
| | Phosphate | | | |
| EEE | Iso-Tridecyl | PEG-5 Cocamine | 15/85 @ 25.1% | PG-20 @ 0.1% |
| | Phosphate | | | |
| FFF | Iso-Tridecyl | PEG-5 Cocamine | 10/90 @ 25.1% | PG-20 @ 0.1% |
| | Phosphate | | | |

Reactions Employing Combinations of Various Phosphate Esters

| | | | | |
|---|---|---|---|---|
| GGG | 15/85 w/w Hexyl | PEG-5 Cocamine | 30/70 @ 25.1% | PG-20 @ 0.1% |
| | Phosphate to | | | |
| | PEG-4 Oleyl | | | |
| | Ether Phosphate | | | |
| HHH | 25/75 w/w C₈-C₁₀ | PEG-5 Cocamine | 30/70 @ 25.1% | PG-20 @ 0.1% |
| | Alkyl Phosphate | | | |
| | to PEG-4 Oleyl | | | |
| | Ether Phosphate | | | |
| III | 20/80 w/w | PEG-5 Cocamine | 30/70 @ 25.1% | PG-20 @ 0.1% |
| | iso-Tridecyl | | | |
| | Phosphate to | | | |
| | PEG-4 Oleyl | | | |
| | Ether Phosphate | | | |
| JJJ | 20/80 w/w PEG-3 | PEG-5 Cocamine | 28/72 @ 25.1% | PG-20 @ 0.1% |
| | C₁₂-C₁₅ Alkyl Ether | | | |
| | Phosphate to | | | |
| | PEG-4 Oleyl | | | |
| | Ether Phosphate | | | |

| | | | Release Testing on PB | | Shim Corrosion Testing on | |
|---|---|---|---|---|---|---|
| | | | (4 press cycles; 7% pMDI; | | 7/16″ OSB (40 press cycles; | |
| | BF Visc., | | RA Dosage = 0.5 dg/sq. ft.) | | RA Dosage = 1.15 dg/sq. ft.) | |
| | 25° C., Sp# | | Wt. | Release | Shim Wt. Gain | Shim Wt. Gain |
| Expt. | 2 @ 100 | pH @ | Pickup on | Rating: | Before | or Loss After |
| No. | rpm, cPs^{†} | 25° C.* | Shim, mg | 0 → 4 | Cleaning, +/− mg | Cleaning, +/− mg |

Reactions Employing Phosphate Ester Ethoxylates (PEE)

| | | | | | | |
|---|---|---|---|---|---|---|
| GG | 56.4 | 7.34 | +4.5 | 3.0 | +13.7 | +3.3 |
| HH | 97.2 | 7.24 | +3.6 | 3.5 | +16.2 | +1.0 |
| II | 200.4 | 7.24 | +4.0 | 4.0 | +17.5 | +6.5 |
| JJ | 32.8 | 7.03 | +11.1 | 2.0 | +34.2 | +15.0 |
| KK | 86.4 | 6.95 | +9.8 | 1.5 | Not Tested | Not Tested |
| | | | | | since Release | since Release |
| | | | | | Rating was <2.5 | Rating was <2.5 |
| LL | 45.2 | 7.51 | +5.1 | 2.0 | Not Tested | Not Tested |
| | | | | | since Release | since Release |
| | | | | | Rating was <2.5 | Rating was <2.5 |
| MM | 46.4 | 7.24 | +3.3 | 3.5 | −33.4 | −46.0 |
| NN | 178.0 | 7.27 | +3.4 | 4.0 | +16.4 | +7.2 |
| OO | 58.0 | 7.04 | +3.2 | 3.5 | +24.5 | +12.5 |
| PP | 50.4 | 7.02 | +3.5 | 4.0 | +23.7 | +10.1 |
| QQ | 42.8 | 7.19 | +7.2 | 2.0 | Not Tested | Not Tested |
| | | | | | since Release | since Release |
| | | | | | Rating was <2.5 | Rating was <2.5 |
| RR | 26.0 | 7.07 | +12.2 | 3.0 | +23.7 | +8.4 |
| SS | 126.4 | 7.45 | +2.5 | 3.5 | +2.2 | −11.2 |
| TT | 209.2 | 7.61 | +6.8 | 2.5 | +7.4 | −3.6 |
| UU | 36.8 | 7.07 | +7.2 | 2.5 | +26.5 | +8.4 |
| VV | 41.6 | 6.63 | +4.3 | 3.0 | +30.8 | +10.5 |
| WW | 42.4 | 6.25 | +2.9 | 3.0 | +39.5 | +14.3 |
| XX | 40.8 | 6.56 | +5.7 | 2.5 | +24.8 | +5.8 |
| YY | 41.2 | 6.42 | +3.7 | 2.5 | +33.0 | +9.0 |

Reactions Employing Alkyl Phosphate Esters (APE)

| | | | | | | |
|---|---|---|---|---|---|---|
| ZZ | 155.2 | 7.14 | +4.1 | 3.5 | +30.0 | +14.7 |
| AAA | 168 | 6.98 | +3.2 | 4.0 | +33.6 | +14.2 |
| BBB | 82.0 | 7.18 | +3.7 | 3.5 | −52.6 | −67.6 |
| CCC | 223.6 | 7.57 | +2.0 | 4.0 | +28.3 | +11.6 |
| DDD | 36.8 | 6.68 | +3.9 | 3.5 | −20.9 | −40.3 |
| EEE | 134.0 | 7.91 | +2.7 | 4.0 | +12.3 | −1.6 |
| FFF | 106.4 | 8.20 | +3.4 | 4.0 | +10.9 | +0.1 |

Reactions Employing Combinations of Various Phosphate Esters

| | | | | | | |
|---|---|---|---|---|---|---|
| GGG | 45.2 | 7.03 | +3.4 | 3.5 | +6.8 | −9.3 |
| HHH | 89.2 | 7.07 | +3.8 | 3.5 | +17.5 | +2.9 |
| III | 154.4 | 7.07 | +3.4 | 3.5 | +20.7 | +3.8 |
| JJJ | 75.6 | 7.22 | +3.8 | 3.5 | +18.7 | +2.8 |

Note:
*The solution pH values were determined at 25° C. using an Oakton pH 450 meter equipped with a standard single junction pH probe (Oakton Model No. 35805-05 in combination with an Oakton ATC probe 35618-05 for temperature compensation).
^{†}The BF Viscosities were all determined at 25° C. using a Brookfield RVDVE Viscometer unit equipped with standard disc spindles (spindle #2 was used unless otherwise noted) and were measured at 100 rpm.
^{‡}The terms 50/50 mono/di and 80/20 mono/di shown in parenthesis refer to the mono-ester to di-ester molar ratios associated with the given phosphate ester chemistry.

A review of the test data in Table VIII indicates that a few select phosphate ester/ethoxylated fatty amine combinations yielded formulations providing very favorable performance properties across all three key criteria (release, minimal film build-up and low metal corrosion loss). Particularly effective external releases were the Expt. HH and the Expt. FFF formulations of Table VIII which both yielded very good release characteristics (with release ratings of 3.5 and 4.0, respectively) and both yielded minimal film build-up and were very effective in mitigating metal corrosion loss (net weight gains after 40 press cycles and post cleaning were only +1.0 mg and +0.1 mg, respectively). The Expt. HH formulation was based on using a PEG-4 oleyl ether phosphate having a 50/50 mole ratio of mono-ester to di-ester species whereas the Expt. FFF formulation was based on using an Iso-Tridecyl Phosphate having a mixture of mono-ester and di-ester species. The former uses a phosphate ester ethoxylate while the latter uses an alkyl phosphate ester which is non-ethoxylated. Given this chemical difference between the phosphate ester types employed, the phosphate ester to ethoxylated fatty amine active basis weight ratio that was optimum to utilize in producing the two release agent formulas was considerably different (28/72 in Expt. HH versus 10/90 in Expt. FFF). Given the generally low release performance characteristics of the ethoxylated fatty amines when used alone as an external release agent it is somewhat surprising that only a 10% content of iso-tridecyl phosphate was needed in Expt. FFF to yield a phosphate ester/ethoxylated fatty amine formula combination that yielded an excellent release rating of 4.0; this surprising release result offers evidence of synergistic combination interactions that provide unexpected benefits.

Other excellent releases were the formulations produced in Expt. HHH, III and JJJ which employed a combination of different phosphate esters strategy. In the case of Expt. HHH and Expt. III the formulations both utilized a combination of phosphate ester ethoxylate plus alkyl phosphate ester types with the PEG-5 cocamine while the formula of Expt. JJJ employed a combination of two different phosphate ester ethoxylates with the PEG-5 cocamine. All three experimental releases yielded very good release characteristics (all had a release rating of 3.5) and all three yielded minimal film build-ups while effectively mitigating metal corrosion losses. Since different types of phosphate esters in the inventive formulations offer different performance profiles the advantage of using a blend strategy is that an experienced formulator can dial in the optimum balance of performance properties desired.

In analogy to performance variations noted above in Example 4, a comparison of the formulations from Expt. HH and Expt. II illustrates the effect that the phosphate ester/PEG-5 cocamine active basis weight ratio can have on overall performance properties. Moving from a phosphate ester/PEG-5 cocamine active basis weight ratio of 28/72 to 30/70, which is a modest adjustment in the release's composition, was found to have a notable impact on release (improving the release rating from 3.5 to 4.0) but had a deleterious effect on film build-up (with the net weights after 40 press cycles and post cleaning increasing from +1.0 mg to +6.5 mg.

A comparison of the Expt. GG and Expt. II formulations with the corresponding Expt. JJ and Expt. KK formulations once again illustrates the impact that the mono-ester to di-diester molar ratio of the phosphate ester can have on final performance properties. The latter pair of release formulations both utilized a PEG-4 oleyl ether phosphate having a higher mono-ester content (i.e., an 80/20 mole ratio of mono-ester to di-ester rather than 50/50). The higher mono-ester content significantly reduced their release performance while also increasing film build-up on the test shims.

In the experimental releases associated with Expt. TT, UU, VV, WW, XX and YY other tertiary ethoxylated fatty amine chemistries beyond PEG-5 cocamine were tested in combination with the PEG-4 oleyl ether phosphate that has a mono-ester to di-ester molar ratio of 50/50. The fatty amine ethoxylates that were explored in these experiments included:
75/25 w/w Ratio Blend of PEG-5 cocamine/PEG-2 cocamine;
PEG-10 cocamine;
PEG-15 cocamine; and
PEG-10 tallowamine.

All combinations of the PEG-4 oleyl ether phosphate with the various ethoxylated fatty amines listed above yielded okay metal protection; however, they in general all yielded too much film buildup on the metal test shims. The one experimental candidate that showed some promise with respect to mitigating corrosion but minimizing film buildup was the release formula for Expt. XX which employed PEG-10 tallowamine. Its film buildup level was more modest (net weight was +5.8 mg) however its release performance was only borderline okay and somewhat lower than what is preferably desired (release rating was 2.5). In general, we prefer to see a minimum release rating of 3.0 to ensure there are no sticking issues in the press. Further experimentation with the PEG-10 tallowamine at different active basis weight ratios of phosphate ester to ethoxylated fatty amine or possibly its use in combination with other phosphate ester chemistries might be able to improve its overall performance profile further but the overall chances of success for these approaches are currently unknown. For now, it appears that the PEG-5 cocamine is our best ethoxylated fatty amine option for use in the inventive release formulations.

It is also noteworthy to point out that some combinations of phosphate ester and ethoxylated fatty amine yielded very poor metal corrosion properties. For example, the release formulations of Expt. MM, Expt. BBB and Expt. DDD all showed large net weight losses on their test shims after 40 press cycles and post-cleaning with the values determined being −46.0 mg, −67.6 mg and −40.3 mg, respectively. All three release formulations employed phosphate esters that have shorter alkyl chains in their chemical structures (namely PEG-2 2-ethylhexyl ether phosphate, 2-ethylhexyl phosphate and hexyl phosphate, respectively). Interestingly, all three formulations yielded very good release characteristics in the PB stress test for release (all had a release rating of 3.5). These findings clearly illustrate that different chemical structures and mechanisms are involved relative to yielding good release properties versus providing good metal protection properties in ligno-cellulose composite press applications. Hence, finding synergistic combinations of phosphate ester and ethoxylated fatty amine to simultaneously yield good performance properties across all three key criteria required rigorous experimentation to discover.

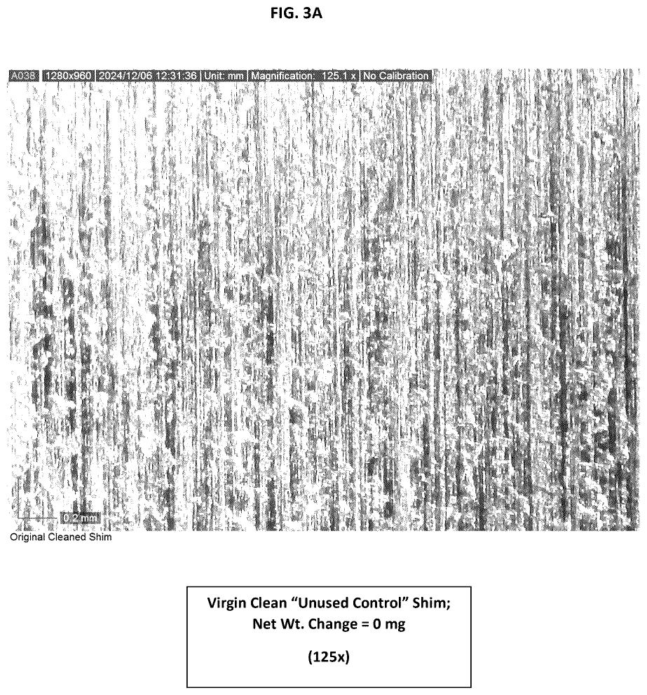

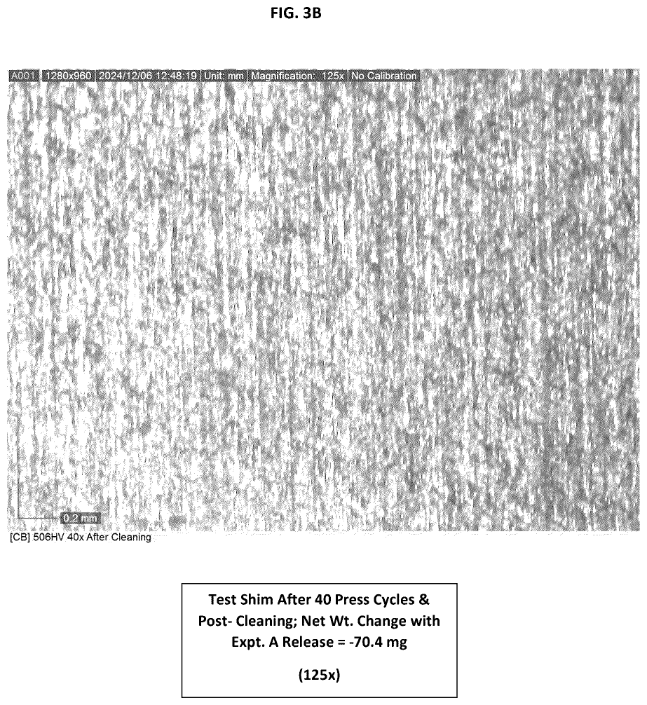

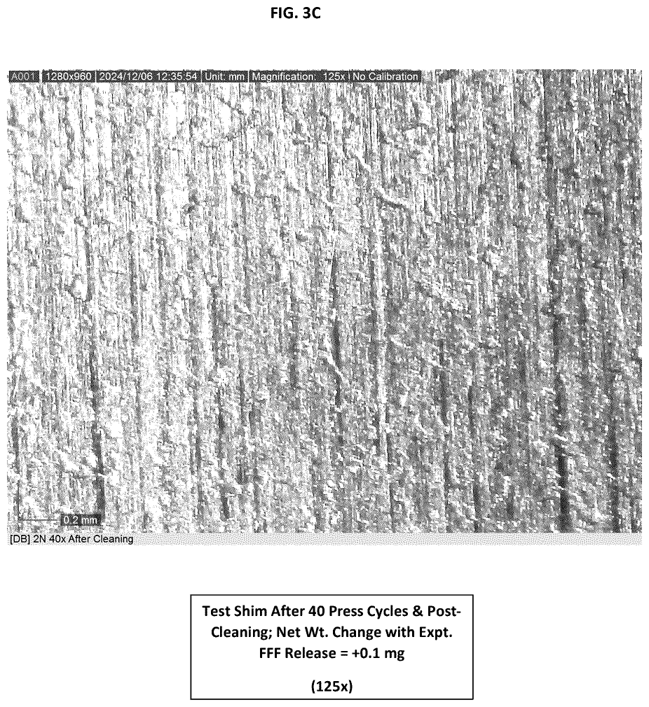

Given the excellent performance characteristics of the Expt. FFF release formulation, we took some comparative micrograph pictures of test shims at 125× magnification using a Keyence Dino-Lite digital microscope unit (see FIGS. 3A-3C). For print publication purposes all the micrographs were taken using a Black/Gray/White color scale. Micrographs of the following were taken for visual comparison:
micrograph of clean, unused control shim (FIG. 3A);
micrograph of metal test shim after being subjected to 40 press cycles and post-cleaning where the commercial release agent TechKote 506HV (denoted as Expt. A in Table IV) had been used (FIG. 3B); and
micrograph of a metal test shim after being subjected to 40 press cycles and post-cleaning where the experimental release agent Expt. FFF per Table VIII had been used (FIG. 3C).

Review of the micrographs presented in FIGS. 3A-C shows that the shim associated with the unused control and the test shim subjected to 40 press cycles using the Expt. FFF release look very similar in surface appearance. Both shims still show the sharp parallel ridge lines on the metal's surface that are typical in thin gauge steels produced by the cold rolling process. In addition, no pitting of the metal surface was observed on the Expt. FFF test shim. Their similar surface appearance was largely anticipated since the metal test shim subjected to 40 press cycles using the Expt. FFF release formula showed a negligible change in its net weight after it was cleaned (only +0.1 mg). In contrast, the metal test shim that was subjected to 40 press cycles using the commercial release agent, Expt. A, looked markedly different than the unused control shim. The surface of this metal test shim appeared dull rather than shiny and while the ridge lines were still visible, they appeared more rounded and eroded away (i.e., less sharp) to a great extent. This erosion/corrosion of the ridge lines correlates well with the notable metal weight loss that was quantified in the Expt. A release testing (its net weight change after cleaning was found to be −70.4 mg).

### Example 6

In this example, the film build-up and corrosion performance of the Expt. FFF formulation of Table VIII was re-investigated at a lower applied dosage to the OSB test panel. The experimental release agent was again reduced in total actives weight content to 10.0% using the appropriate amount of 40 ppm hardness dilution water for subsequent spray application. In this test, the 10% active release solution was spray-applied at an application dosage level of just 0.5 dg/sq. ft. to discern its effectiveness at this lower application level. All previous testing in Examples 4 and 5 was done at a higher application dosage level of 1.15 dg/sq. ft. from the perspective that most OSB manufacturers have historically viewed the release agent as the principal culprit for causing corrosive metal loss (so in their view using higher release agent dosages meant getting more potential corrosion). Since the release agents of the present invention have instead proven themselves to function as a corrosion inhibitor and as metal surface protectant, we therefore wanted to see what would happen when applying a low dosage level of release, like 0.50 dg/sq. ft., for the release formula of Expt. FFF.

After completing 40 press cycles using our lab test protocol, the net weight changes associated with the set of metal test shims were as follows:

$$Average Net Weight Change Before Post - Cleaning = + 9.1 mg$$

$$Average Net Weight Change After Post - Cleaning = + 0.6 mg$$

This testing indicates that the Expt. FFF release formula still offers excellent protection against metal shim corrosion when utilized at very low dosage application levels like 0.50 dg/sq. ft. The utility of this release agent in the manufacture of OSB should therefore be excellent when more typical industry applications levels of about 0.8 dg/sq. ft. are utilized.

### Example 7

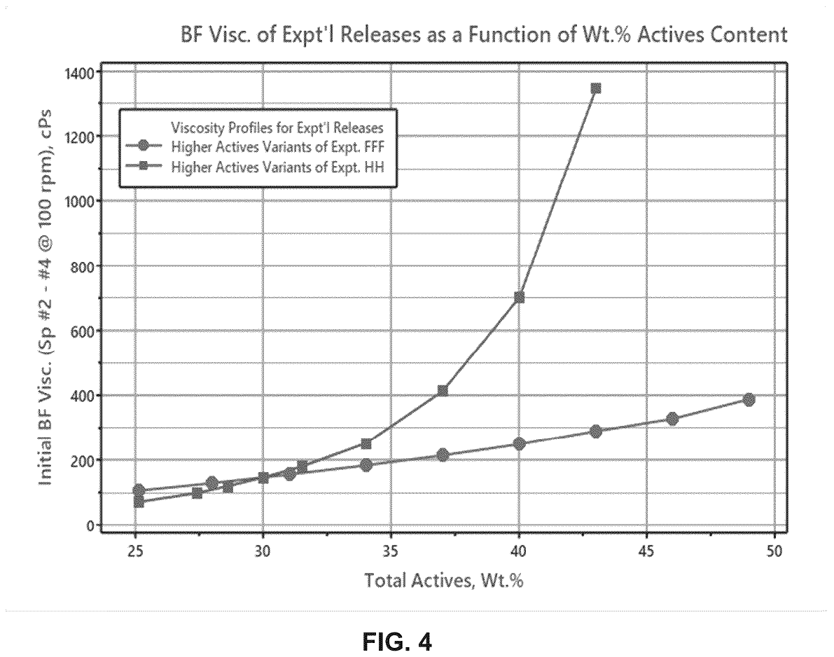

Given the excellent performance characteristics noted for the Expt. HH and Expt. FFF release formulations of Example 5, investigations were undertaken to both further to determine how high their total actives contents in weight % could be increased and still maintain a stable, pumpable waterborne concentrate formulation. In both cases their formulations were increased in total actives content by proportionally increasing the amounts of phosphate ester and ethoxylated fatty amine being used (thereby keeping their active basis weight ratio the same) and the balance of batch DI water was then adjusted as needed to keep the total batch weight constant. On this basis, a series of test batches of increasing total actives content in weight % were produced and then characterized in terms of their initial Brookfield viscosity properties. The higher actives content formula variants derived from Expt. HH and from Expt. FFF are comparatively shown in FIG. 4 whereby their initial Brookfield Viscosity values were determined at 25° C. with an appropriate disc spindle at 100 rpm.

The Brookfield viscosity profile curves graphed in FIG. 4 show that at lower total actives contents ranging from about 25% by wt. to about 32.5% by wt. the two experimental release formulations have similar Brookfield viscosity values at 25° C. as measured at 100 rpm. However, as the total actives content is increased above 32.5% by weight their viscosity response profiles are very different as discussed below.

The higher actives content variants of Expt. HH dramatically increased in viscosity in an exponential-like manner as the total actives content was incrementally increased up to 43% by weight. Based on mixing considerations, about 37% by weight is about the maximum total actives content that the Expt. HH based formulation can be easily produced. Batches produced at 40% and 43% by wt. total actives content were considerably more difficult to mix and upon aging at room temperature (about 22° C.) both formula variants turned into viscous gels. In contrast, the variants of Expt. FFF increased in Brookfield viscosity in a linear manner as the total actives content was incrementally increased. At 37% by wt. total actives content the Expt. FFF based formula is about half the BF viscosity of the analogous Expt. HH variant (218.4 cPs versus 428.0 cPs, respectively, as measured at 100 rpm) and it was considerably easier to produce via the use of simple stirred mixing equipment. Furthermore, as shown in Table IX below, the viscosity value of the Expt. FFF formula variant of 37% by wt. total actives content showed dependence on its storage temperature whereby aged Brookfield viscosities increased as the storage temperature was decreased. Over the storage temperature range from 40° C. down to 5° C., the formula's Brookfield viscosity, as measured at 100 rpm, increased from about 113 cPs to about 410 cPs; however, the test batches plateaued off at a particular viscosity level for a given storage temperature condition and were subsequently stable at that temperature. Hence, at a given storage temperature, they did not continue to change in Brookfield viscosity over additional periods of aging time and no precipitation or phase separation issues were noted. Lastly, the highest 100 rpm Brookfield viscosity of 410 cPs that was obtained at 5° C. is still very manageable from a pumpability standpoint and resides below the preferred maximum 100 rpm Brookfield viscosity level of 500 cPs that was recommended in the summary of the invention section.

TABLE IX
BF Viscosity of Expt. FFF Formula Variant of 37.0% by Wt. Total
Actives Content as Function of Its Age Time & Temperature

| | Brookfield Viscosity Values* Over Time, in cPs | | | |
|---|---|---|---|---|
| Batch Storage | | Aged | Aged | Aged |
| Temp., ° C. | Initial | 1-Week | 2-Weeks | 3-Weeks |
| Oven | — | 112.8 | 113.6 | 112.4 |
| (40° C.) | | | | |
| Room Temp | 218.4 | 278.0 | 276.0 | 285.6 |
| (22-25° C.) | | | | |
| Water Batch | — | 393.6 | 396.0 | 391.2 |
| (10° C.) | | | | |
| Refrigerator | — | 410.0 | 410.0 | 409.0 |
| (5° C.) | | Sp #3 | Sp #3 | Sp #3 |

Note:
*The Brookfield Viscosities were all determined over time at their noted storage temperature using a Brookfield RVDVE Viscometer unit equipped with standard disc spindles (spindle #2 was used unless otherwise noted) and were measured at 100 rpm.

### Example 8

In this example the metal corrosion and film buildup performance of the Expt. HH release formula of Table VIII was verified by re-conducting the testing on a larger pilot scale press, a 34″×34″ 450-ton Dieffenbacher hydraulic hot press, employed at a press temperature of 415° F. The fundamentals of the corrosion and film buildup testing remain essentially the same as previously described for the lab-based protocol described above except that OSB strands supplied by an engineered wood mill were formed into a mat and used in the pressing experiments rather than using the pre-formed 7/16″ OSB panels. Single layer hand-formed mats that were ⅜″×16″×16″ in dimension were formed targeting a density of 38-40 pcf and having an out-of-press moisture content of about 3%. Other process related parameters were as follows:
2% target pMDI loading was used utilizing Wanhua Chemical resin Wannate PM-200 which has an isocyanate NCO content of about 31.7%;
0.5% active basis wax employing a 50% active wax emulsion was employed as an internal release agent;
the release agent, formula per Expt. HH, was prediluted to 10% actives content using ppm hardness water and spray-applied to the top of the mat manually using a pneumatic paint sprayer at a target application level of 1.50 dg/sq. ft.;
four pieces of 6″×6″ metal shim stock (Precision Brand, Mfr #16590; 0.002″ thick; 1008-1010 grade low carbon steel) were utilized as the test shims and laid on the OSB strand mat prior to pressing. Clean shims before use typically weighed between 9.10 to 9.20 g. A 0.125″×16′×16″ steel caul plate was then placed on top of the mat with its four test shims.
Test shims were primed and baked with release before use.
Shims were cleaned with acetone rather than with the IPA+MEK solvents in this testing.
After 40 press cycles the net weight changes associated with the set of test shims were as follows:
   Average Net Weight Change Before Post-Cleaning=+17.7 mg
   Average Net Weight Change After Post-Cleaning=+3.7 mg
   Average Net Change in Wt. %=+0.04%

In summary, the above test results are very comparable to those generated on the Expt. HH release formula per the performance data reported for it in Table VIII using the lab-based testing protocol. The small difference in their average net weight change after post-cleaning the shims (+1.0 mg versus+3.7 mg) can be easily attributed to the difference in release agent dosage that was applied (namely, 1.15 dg/sq. ft in the lab press study versus 1.50 dg/sq. ft. in the pilot press study) and to the difference in metal shim grades that was employed in the test runs. The surface of the 0.002″ thick metal shims used in this pilot testing are notably smoother than the surface of the 0.01″ thick metal shims used in the lab test protocol. When taking into the minor changes in testing protocol and application dosage, this pilot press data using OSB strands for forming the mat therefore verifies the overall usefulness of the lab protocol that has been developed and utilized as a quicker screening tool for assessing film build-up and corrosive metal losses associated with the use of external release agents.

In another aspect of the invention, there is provided a method for applying an external release agent to a ligno-cellulose fiber, chip, strand or particle mat or to the metal surface of a press used in the manufacturing of engineered wood composite products that employ an isocyanate-based adhesive, such as pMDI, the method as follows:
1. Providing the water-borne external release agent derived from combining one or more acidic phosphate ester chemistries, that consists of one or more acidic alkyl phosphate esters (as compositionally defined above) or consists of one of more acidic phosphate ester ethoxylates (as compositionally defined above) or consists of a combined blend of these acidic alkyl phosphate esters plus acidic phosphate ester ethoxylates, with one or more tertiary ethoxylated fatty amines (as compositionally defined above) whereby the acidic phosphate ester(s) plus ethoxylated fatty amine(s) are combined in water in accordance with either the two step formulation process depicted in FIG. 1 or the direct neutralization process depicted in FIG. 2. The combination of acidic phosphate ester(s) plus ethoxylated fatty amine(s) that is employed, using either the formulation process of FIG. 1 or FIG. 2, compositionally ranges from a total phosphate ester or phosphate ester, alkali metal salt to total ethoxylated fatty amine active basis weight ratio of about 5/95 to about 40/60, respectively, or more preferably from about 10/90 to about 30/70 wherein the acidic phosphate esters being employed are a blend of mono-ester and di-ester species typically falling within a mono-ester to di-ester mole ratio range of about 90/10 to about 50/50, respectively. The external release formulation can optionally contain other minor additives in it such as a defoamer additive (in amounts up to 0.3% by wt. of the total formulation weight) or an optional nonionic surfactant having an HLB value of 3-16 in amounts up to 3.0% by wt. of the total actives content of the formulation (which is the combined weight amounts of the phosphate ester(s) or phosphate ester, alkali metal salt(s) plus ethoxylated fatty amine(s) plus optional defoamer) whereby the total actives content of the finished release formulation ranges from about 5.0-50.0% by weight.
2) Then transferring the external release agent formulation of step 1 into an application system at the engineered wood mill whereby the total actives content of the formulation is subsequently diluted with water as needed to sufficiently reduce its Brookfield viscosity for providing a uniform distribution of release agent. For atomized spray application onto a ligno-cellulose mat the total actives content of the external release formulation that is applied commonly ranges from about 5.0-15.0% by weight and will ideally have a Brookfield viscosity (as measured at 100 rpm) of 75 cPs or less.
3) Then thereafter applying an effective amount of the external release agent to a ligno-cellulosic fiber, chip, strand or particle mat (or combinations of these ligno-cellulose materials) or to the metal surface of a press or to both the mat and metal surfaces using said application system prior to forming the pressed composite. An effective active basis amount of the external release agent to be applied to the surface of the ligno-cellulose mat or to the metal surface of a press or to both surfaces can range from about 0.1 dg/sq. ft. to about 2.0 dg/sq. ft. per surface but more commonly ranges from about 0.25 dg/sq. ft. to about 1.5 dg/sq. ft. whereby the dg unit denotes “dry gram basis”. In addition, the metal pressing surface can be initially primed with the external release agent of the present invention before beginning a production campaign to make a ligno-cellulose composite and the external release agent of the present invention can also be utilized in combination with various internal release agents known in the prior art, such as waxes, so long as the internal release chemistries do not interfere with any of its multi-functional performance characteristics as discussed above.

The inventive formulation can be used in virtually any processing scheme to make an engineered wood composite product that requires a release agent to minimize sticking of the product to components of the press, a corrosion inhibitor to minimize the corrosion to the metal components of the press, and an anti-masking agent to minimize the buildup of material on the press that can cause undue maintenance and loss of production efficiency. As such, an invention has been disclosed in terms of preferred embodiments thereof which fulfills each and every one of the objects of the present invention as set forth above and provides a new and improved release agent and corrosion inhibitor formulation which also simultaneously minimizes film buildup on the press for making engineered wood composite products.

Of course, various changes, modifications and alterations from the teachings of the present invention may be contemplated by those skilled in the art without departing from the intended spirit and scope thereof. It is intended that the present invention only be limited by the terms of the appended claims.

We claim:

1. A release agent and corrosion inhibitor formulation that yields minimal film buildup comprising:
at least one tertiary ethoxylated fatty amine having formula (I) 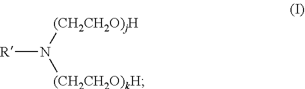
wherein R′=C₈-C₂₀ linear or branched, saturated or unsaturated aliphatic group, and subscripts j+k=2-20 moles of ethylene oxide content on average, and
at least one of an acidic alkyl phosphate ester and an acidic phosphate ester ethoxylate, or combinations thereof, having formula (II) 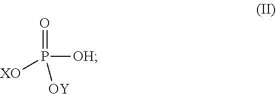
wherein X=C₆-C₁₄ aliphatic carbon chain (either linear or branched) and Y=H or C₆-C₁₄ aliphatic carbon chain (either linear or branched) for the acidic alkyl phosphate ester; and
wherein X=—(CH₂CH₂O)_{z}—R where R=a C₆-C₂₀ aliphatic carbon chain (linear or branched; saturated or unsaturated) and z=2-10 units of ethylene oxide content and Y=H or —(CH₂CH₂O)_{z}—R where R=a C₆-C₂₀ aliphatic carbon chain (linear or branched; saturated or unsaturated) and z=2-10 units of ethylene oxide content, for the acidic phosphate ester ethoxylate; and
water;
wherein an active basis weight ratio of the at least one of an acidic alkyl phosphate ester and an acidic phosphate ester ethoxylate or combination thereof to the at least one tertiary ethoxylated fatty amine ranges between about 5/95 to about 60/40; and
wherein a total actives content of the formulation ranges between about 5 and about 50% by weight of the total formulation, the balance being water.

2. The formulation of claim 1, wherein the active basis weight ratio ranges between about 10/90 and about 30/70.

3. The formulation of claim 1, further comprising a defoamer in an effective amount to reduce process foam when making the formulation or diluting the formulation.

4. The formulation of claim 3, wherein the effective amount of the defoamer is between zero and up to 0.3% by weight of the total formulation.

5. The formulation of claim 1, further comprising an effective amount of a nonionic surfactant having an HLB (hydrophilic lipophilic balance) value of about 3 to about 16 to improve wetting, reduce formulation viscosity and/or to serve as a hydrotrope to improve solubility.

6. The formulation of claim 5, wherein the effective amount of the nonionic surfactant is up to 3.0% by weight of the total actives content.

7. The formulation of claim 3, further comprising an effective amount of a nonionic surfactant having an HLB (hydrophilic lipophilic balance) value of about 3 to 16 to improve wetting, reduce formulation viscosity and/or to serve as a hydrotrope to improve solubility.

8. The formulation of claim 7, wherein the effective amount of the nonionic surfactant is up to 3.0% by weight of the total actives content.

9. The formulation of claim 1, wherein the formulation includes the at least one acidic alkyl phosphate ester.

10. The formulation of claim 1, wherein the formulation includes the at least one acidic phosphate ester ethoxylate.

11. The formulation of claim 1, wherein the formulation includes the combination of the at least one acidic alkyl phosphate ester and the at least one acidic phosphate ester ethoxylate.

12. The formulation of claim 1, wherein the at least one tertiary ethoxylated fatty amine is selected from the group consisting of PEG-5 cocamine, 75/25 w/w of PEG-5 cocamine to PEG-2 cocamine, PEG-10 cocamine, PEG-15 cocamine, and PEG-10 tallowamine.

13. The formulation of claim 9, wherein the at least one acidic alkyl phosphate ester is selected from the group consisting of C₈-C₁₀ alkyl phosphate, 2-ethylhexyl phosphate, C₁₂-C₁₄ alkyl phosphate, hexyl phosphate, and iso-tridecyl phosphate.

14. The formulation of claim 10, wherein the acidic phosphate ester ethoxylate is selected from the group consisting of PEG-4 oleyl ether phosphate (50/50 mono/di), PEG-4 oleyl ether phosphate (80/20 mono/di), PEG-2 2-ethylhexyl ether phosphate, PEG-3 C₁₂-C₁₅ alkyl ether phosphate, PEG-2 C₁₂-C₁₄ alkyl ether phosphate, PEG-3 C₁₂-C₁₄ alkyl ether phosphate, PEG-4 C₁₂-C₁₄ alkyl ether phosphate, and PEG-3 iso-tridecyl ether phosphate.

15. The formulation of claim 11, wherein the combination of the at least one of an acidic alkyl phosphate ester and the acidic phosphate ester ethoxylate is selected from the group consisting of 15/85 w/w hexyl phosphate to PEG-4 oleyl ether phosphate, 25/75 w/w C₈-C₁₀ alkyl phosphate to PEG-4 oleyl ether phosphate, 20/80 w/w iso-tridecyl phosphate to PEG-4 oleyl ether phosphate; and 20/80 w/w PEG-3 C₁₂-C₁₅ alkyl ether phosphate to PEG-4 oleyl ether phosphate.

16. The formulation of claim 1, wherein the at least one tertiary ethoxylated fatty amine is PEG-5 cocamine (Ethox CAM-5) and the at least one of an acidic alkyl phosphate ester and an acidic phosphate ester ethoxylate, or combinations thereof is either PEG-4 oleyl ether phosphate having 50/50 molar ratio of mono-ester to di-ester (Ethfac 140) or is iso-tridecyl phosphate (Ethfac 103).

17. The formulation of claim 1, further comprising an effective amount of phosphate ester amine salt for corrosion inhibition.

18. The formulation of claim 1, wherein the formulation has an initial Brookfield viscosity, as measured at 25° C. using a #2-4 disc spindle at 100 RPM, of less than 500 cPs, and an aged viscosity as measured using a #2-4 disc spindle at 100 RPM, measured over 1 to 3 weeks and at temperatures ranging from 5 to 40° C., of less than 500 cPs.

19. The formulation of claim 1, wherein the water is neither softened nor deionized.

20. The formulation of claim 1, further comprising an alkali metal salt species of the at least one of an acidic alkyl phosphate ester and an acidic phosphate ester ethoxylate, or combinations thereof, the formulation having a pH falling between about 9.0 and about 10.5 as measured at 25° C.

21. A method of applying a release agent to a mat made of a lignocellulosic fiber, chip, strand, or particle and/or a metal surface of a metal platen used in the manufacture of engineered wood composite products comprising:
providing the formulation of claim 1; and
applying an effective amount of the formulation to the mat and/or the metal surface to improve release between the mat and the metal surface, inhibit corrosion of the metal surface, and reduce build up on the metal surface.

22. The method of claim 21, wherein the formulation is diluted to a total actives content ranging between about 5 and 15%.

23. The method of claim 21, wherein the formulation is applied to both the mat and the metal surface.

24. The method of claim 21, wherein the formulation is applied to the metal surface or mat at a dosage level between about 0.1 dg/sq. ft. and about 2.0 dg/sq. ft., wherein dg denotes dry gram basis and sq. ft. applies to surface area of the mat or metal surface.

25. The method of claim 24, wherein the dosage level is between about 0.25 dg/sq. ft. and about 1.5 dg/sq. ft.

26. The method of claim 21, wherein the mat utilizes an isocyanate-based adhesive, and optionally includes an internal release agent, preferably a wax.

27. The method of claim 21, further comprising forming the mat into an engineered wood composite product using a heated metal pressing surface, wherein, during the forming step, the formulation reduces transport of acidic wood extractives species in the mat to an interface between the mat and the metal pressing surface and assists in neutralizing acidic wood extractive species that exist in the interface as a result of reaction with the at least one tertiary ethoxylated fatty amine of the formulation.
